(19) United States
(12) Patent Application Publication
(10) Pub. No.: US 2023/0035870 A1
(43) Pub. Date: Feb. 2, 2023

(54) INKJET PRINTER AND METHOD OF CONTROLLING INKJET PRINTER

(71) Applicant: MIMAKI ENGINEERING CO., LTD., Nagano (JP)

(72) Inventors: Soichiro Takehana, Nagano (JP); Katsutoshi Yamabe, Nagano (JP)

(73) Assignee: MIMAKI ENGINEERING CO., LTD., Nagano (JP)

(21) Appl. No.: 17/785,411

(22) PCT Filed: Dec. 10, 2020
(86) PCT No.: PCT/JP2020/045953

§ 371 Date: Jun. 15, 2022

(30) Foreign Application Priority Data
Dec. 19, 2019 (JP) 2019-228746

(51) Int. Cl. B41J 2/045

(52) U.S. Cl. CPC B41J 2/04563; B41J 2/04581

(57) ABSTRACT

A controller 10 activates a heater 21 when a temperature detected by a temperature sensor 13 for detecting a temperature of ink becomes lower than a first reference temperature Ta lower than the appropriate ink ejection temperature Ta at the time of printing pause in which printing is paused. After the heater 21 is activated, when the temperature detected by the temperature sensor 13 exceeds a predetermined second reference temperature T2 that is higher than the first reference temperature T1 and lower than the appropriate ink ejection temperature Ta, the controller 10 moves the inkjet head to the maintenance region and forcibly discharges ink from the inkjet head in the maintenance region.

### TECHNICAL FIELD

The present invention relates to an inkjet printer and a method of controlling the inkjet printer.

### BACKGROUND ART

An inkjet printer includes an inkjet head that ejects ink, a carriage on which the inkjet head is mounted, and a carriage drive mechanism that moves the carriage in a main scanning direction (see e.g., Patent Literature 1). In the inkjet printer described in Patent Literature 1, a pressure adjusting damper for adjusting the internal pressure of the inkjet head to a negative pressure is provided in an ink supply path connecting an ink cartridge attached to a printer main body and the inkjet head.

(A) and (B) of FIG. 15 are enlarged cross-sectional views for describing a configuration of a pressure adjusting damper according to a conventional technique.

As illustrated in FIG. 15, the pressure adjusting damper includes a damper main body part 100. In the damper main body part 100, an opening valve accommodation chamber 102 in which an opening valve 101 is accommodated and a sealing valve accommodation chamber 104 in which a sealing valve (sealing valve) 103 is accommodated are formed. The opening valve accommodation chamber 102 and the sealing valve accommodation chamber 104 are connected via a communication hole 105. The opening valve accommodation chamber 102 accommodates ink flowing out toward the inkjet head, and the sealing valve accommodation chamber 104 accommodates ink flowing in from the ink cartridge.

As shown in (A) of FIG. 15, the sealing valve 103 is biased in a direction of closing the communication hole 105 by a spring 106, and closes the communication hole 105 when ink is not ejected from the inkjet head. The opening valve accommodation chamber 102 is sealed by a flexible film 107 fixed to the damper main body part 100. The opening valve 101 is biased in a direction away from the sealing valve 103 by a spring 108. The center portion of the flexible film 107 is pushed toward the outer side of the damper main body part 100 by the opening valve 101 biased by the spring 108. In (B) of FIG. 15, the springs 106 and 108 are not illustrated.

In the inkjet printer described in Patent Literature 1, when ink is ejected from the inkjet head, the internal pressure of the inkjet head and the internal pressure of the opening valve accommodation chamber 102 decrease. Due to the decrease in the internal pressure, the flexible film 107 is deformed toward the inner side of the damper main body part 100, and the ink corresponding to the ejection amount is supplied from the opening valve accommodation chamber 102 to the inkjet head. When a predetermined amount of ink is ejected from the inkjet head, as shown in (B) of FIG. 15, the flexible film 107 is deformed by a predetermined amount toward the inner side of the damper main body part 100, and the distal end of the opening valve 101 comes into contact with the sealing valve 103. As a result, the sealing valve 103 moves in a direction of opening the communication hole 105.

When the sealing valve 103 moves in the direction of opening the communication hole 105, ink is supplied from the sealing valve accommodation chamber 104 to the opening valve accommodation chamber 102 via the communication hole 105 (see arrow in (B) of FIG. 15). When the ink is supplied to the opening valve accommodation chamber 102, the internal pressure of the opening valve accommodation chamber 102 increases. The flexible film 107 is deformed toward the outer side of the damper main body part 100 by the increase in the internal pressure. Accompanying the deformation, the opening valve 101 moves in a direction away from the sealing valve 103 by the biasing force of the spring 108. When the opening valve 101 moves in a direction away from the sealing valve 103, the communication hole 105 is closed by the sealing valve 103, and the supply of ink from the sealing valve accommodation chamber 104 to the opening valve accommodation chamber 102 is stopped.

Furthermore, the inkjet printer includes an ink warming device (head-exterior warming device) that warms the ink supplied to the inkjet head (see e.g., Patent Literature 2). In the inkjet printer described in Patent Literature 2, an ultraviolet curable ink is ejected from an inkjet head. The ink warming device is disposed outside the inkjet head. The ink warming device has a function of warming the ink ejected from the inkjet head to a predetermined appropriate temperature to lower the viscosity of the ink ejected from the inkjet head.

### CITATION LIST

### Patent Literature

Patent Literature 1: Japanese Unexamined Patent Publication No. 2011-46070
Patent Literature 2: Japanese Unexamined Patent Publication No. 2015-168243

### SUMMARY OF INVENTION

### Technical Problems

In an inkjet printer, consideration has been made to install an ink warming device in an ink supply path between a pressure adjusting damper and an inkjet head to warm the ink supplied to the inkjet head. Here, when a printing pause state (printing stop state) in which printing is not performed by the inkjet printer continues for a certain period of time, the temperature of the ink in the inkjet head becomes lower than a predetermined temperature. The inventors of the present application have found that when the ink of a low temperature is warmed by the ink warming device to an appropriate temperature to perform printing, the ink drip from the nozzles of the inkjet head may occur before the temperature of the ink reaches a temperature appropriate for ejection.

The inventors of the present application first have attempted to investigate the cause of ink leakage from the nozzles of the inkjet head when the ink in the inkjet head, whose temperature has dropped during the printing pause, is warmed by the ink warming device. As a result, it has become clear that when the temperature of the ink in the inkjet head becomes lower than a predetermined temperature, the ink shrinks and the volume of the ink decreases. Thus, the internal pressure of the inkjet head, the internal pressure of the ink warming device, and the internal pressure of the opening valve accommodation chamber 102 decrease, and the ink flows from the sealing valve accommodation chamber 104 into the opening valve accommodation chamber 102. Thereafter, when the ink is warmed by the ink warming device, the ink expands and the volume of the ink increases, and the internal pressure of the inkjet head, the internal pressure of the ink warming device, and the internal pressure of the opening valve accommodation chamber 102 increase.

When the internal pressure of the opening valve accommodation chamber 102 increases, the flexible film 107 is deformed toward the outer side of the damper main body part 100. Accompanying the deformation, the opening valve 101 moves in a direction away from the sealing valve 103 by the biasing force of the spring 108. Therefore, even if the internal pressure of the opening valve accommodation chamber 102 increases, the communication hole 105 is opened, and the ink does not flow back from the opening valve accommodation chamber 102 to the sealing valve accommodation chamber 104. That is, even if the internal pressure of the inkjet head, the internal pressure of the ink warming device, and the internal pressure of the opening valve accommodation chamber 102 increase, the ink cannot be flowed back from the inkjet head to the ink supply side.

As described above, when the temperature of the ink in the inkjet head becomes low, the ink flows from the sealing valve accommodation chamber 104 into the opening valve accommodation chamber 102. As the ink is warmed by the ink warming device, the internal pressure of the inkjet head, the internal pressure of the ink warming device, and the internal pressure of the opening valve accommodation chamber 102 become higher than the internal pressure before the printing pause state. When the internal pressure of the inkjet head eventually becomes a positive pressure, the ink that has flowed into the opening valve accommodation chamber 102 leaks from the nozzle of the inkjet head, and drip occurs.

A first object of the present invention is thus to provide an inkjet printer capable of preventing ink leakage from the nozzle of the inkjet head when the ink is warmed in the inkjet printer.

Furthermore, the first object of the present invention is to provide a method of controlling an inkjet printer capable of preventing ink leakage from the nozzle of the inkjet head when the ink is warmed in the inkjet printer.

Furthermore, in the inkjet printer, an inkjet head having a plurality of ink flow paths formed therein may be used. For example, in an inkjet printer, an inkjet head in which four ink flow paths through which each of the inks of four colors of magenta (M), yellow (Y), cyan (C), and black (B) flow are formed may be used. In this case, a plurality of nozzles that eject each of the inks of four colors are formed in the inkjet head. That is, a plurality of nozzles connected to each of the four ink flow paths are formed in the inkjet head. In addition, the inkjet head includes a piezoelectric element (piezoelectric element) for ejecting ink from each of the plurality of nozzles.

In a case where an inkjet head in which a plurality of ink flow paths are interiorly formed is used in the inkjet printer, it has become clear through studies of the inventors of the present application that ink drip from the nozzles of the inkjet head occurs during printing depending on the print conditions. Specifically, only ink of a specific color may be continuously ejected during a predetermined time during printing. That is, when the usage amount of the ink of a specific color is large but the usage amount of the ink of another color excluding the specific color becomes small, the ink leakage from the nozzles of the inkjet head may occur.

That is, the drip may occur under the print condition that the total sum of the ejection amounts of the ink ejected from the plurality of nozzles connected to a specific ink flow path is large but the total sum of the ejection amounts of the ink ejected from the plurality of nozzles connected to the other ink flow paths excluding the specific ink flow path is small during the predetermined time during printing. That is, in a case where only the ink of a specific color is continuously ejected but the ink of other colors excluding the specific color is not ejected for a predetermined time during printing, the ink leakage from the nozzles of the inkjet head may occur.

As a result of intensive studies on the cause of the occurrence of drip under these print conditions, the inventors of the present application have found that when the total sum of the ejection amounts of ink ejected from the nozzles connected to specific ink flow paths is large, the number of times of driving of the piezoelectric element for ejecting ink from these nozzles increases, and heat is generated from the piezoelectric element. Due to the influence of heat, the ink retained in the other ink flow paths excluding the specific ink flow path is excessively warmed. When the ink is excessively warmed, it expands and increases in volume. As a result, the internal pressure of the ink flow path in which the ink is retained and the internal pressure of the opening valve accommodation chamber 102 may be excessively increased.

As described above, even if the internal pressure of the opening valve accommodation chamber 102 increases, the communication hole 105 is closed, and hence the ink does not flow back from the opening valve accommodation chamber 102 to the sealing valve accommodation chamber 104. Thus, when the internal pressure of the ink flow path and the internal pressure of the opening valve accommodation chamber 102 are excessively increased, the internal pressure of the ink flow path in which the ink is retained becomes a positive pressure. As a result, the ink retained in the ink flow path may leak from the nozzle of the inkjet head and drip may occur.

Therefore, a second object of the present invention is to provide an inkjet printer including an inkjet head in which a plurality of ink flow paths are formed, the inkjet printer being capable of preventing leakage of ink from the nozzles of the inkjet head when the total sum of the ejection amounts of ink ejected from a plurality of nozzles connected to a specific ink flow path is large and the total sum of the ejection amounts of ink ejected from a plurality of nozzles connected to other ink flow paths is small.

Furthermore, a second object of the present invention is to provide a method of controlling an inkjet printer including an inkjet head in which a plurality of ink flow paths are formed, the method being capable of preventing leakage of ink from the nozzles connected to an ink flow path other than the specific ink flow path when ink is continuously ejected only from the nozzle connected to a specific ink flow path during printing.

### Solutions to Problems

In order to solve the first problem described above, an inkjet printer of the present invention is an inkjet printer that performs printing by ejecting ink, the inkjet printer including an inkjet head that ejects ink; a carriage on which the inkjet head is mounted; a carriage drive mechanism that moves the carriage in a main scanning direction; a pressure adjustment mechanism that accommodates the ink supplied to the inkjet head and adjusts an internal pressure of the inkjet head; an ink warming mechanism that is disposed between the pressure adjustment mechanism and the inkjet head in an ink supply path to the inkjet head and warms the ink supplied to the inkjet head; a temperature sensor for detecting a temperature of the ink; and a controller that controls the inkjet printer; where the ink warming mechanism includes a warming part main body that is block-shaped, an ink passing portion that is formed inside the warming part main body and through which ink passes, and a heater that heats the warming part main body; the temperature sensor directly or indirectly detects a temperature of ink inside the inkjet head or a temperature of ink in the ink passing portion; assuming that a region deviated in the main scanning direction from a printing region where printing is performed is a maintenance region, the controller ejects ink from the inkjet head to perform printing when a temperature detected by the temperature sensor becomes an appropriate ink ejection temperature, and the controller activates the heater when a temperature detected by the temperature sensor becomes lower than a first reference temperature lower than the appropriate ink ejection temperature at a time of printing pause when printing is paused, and when the temperature detected by the temperature sensor exceeds a second reference temperature higher than the first reference temperature and lower than the appropriate ink ejection temperature after activation of the heater, moves the inkjet head to the maintenance region and forcibly discharges the ink from the inkjet head in the maintenance region.

In order to solve the first problem described above, a method of controlling an inkjet printer of the present invention is a method of controlling an inkjet printer that includes an inkjet head that ejects ink; a carriage on which the inkjet head is mounted; a carriage drive mechanism that moves the carriage in a main scanning direction; a pressure adjustment mechanism that accommodates the ink supplied to the inkjet head and adjusts an internal pressure of the inkjet head; an ink warming mechanism that is disposed between the pressure adjustment mechanism and the inkjet head in an ink supply path to the inkjet head and warms the ink supplied to the inkjet head; and a temperature sensor for detecting a temperature of the ink; the ink warming mechanism including a warming part main body that is block-shaped, an ink passing portion that is formed inside the warming part main body and through which ink passes, and a heater that heats the warming part main body; and the temperature sensor directly or indirectly detecting a temperature of ink inside the inkjet head or a temperature of ink in the ink passing portion; where assuming that a region deviated in the main scanning direction from a printing region where printing is performed is a maintenance region, when a temperature detected by the temperature sensor reaches a predetermined appropriate ink ejection temperature, ink is ejected from the inkjet head to perform printing, and when a temperature detected by the temperature sensor becomes lower than a first reference temperature lower than the appropriate ink ejection temperature at a time of printing pause when printing is paused, the heater is activated, and when the temperature detected by the temperature sensor exceeds a second reference temperature higher than the first reference temperature and lower than the appropriate ink ejection temperature after activation of the heater, the inkjet head is moved to the maintenance region and ink is forcibly discharged from the inkjet head in the maintenance region.

In the present invention, the second reference temperature is set such that the internal pressure of the inkjet head when the temperature detected by the temperature sensor becomes the second reference temperature becomes a negative pressure. That is, in the present invention, the second reference temperature is set such that the internal pressure of the inkjet head when the temperature detected by the temperature sensor becomes the second reference temperature does not become a positive pressure.

In the present invention, the heater is activated in a state where the temperature detected by the temperature sensor is lower than the predetermined first reference temperature lower than the appropriate ink ejection temperature at the time of printing pause (printing stop) in which printing is paused. After the heater is activated, when the ink is warmed by the ink warming mechanism and the temperature detected by the temperature sensor exceeds a predetermined second reference temperature that is higher than the first reference temperature and lower than the appropriate ink ejection temperature, the inkjet head is moved to the maintenance region, and the ink is forcibly discharged from the inkjet head in the maintenance region.

Thus, in the present invention, the second reference temperature is set such that the internal pressure of the inkjet head when the temperature detected by the temperature sensor becomes the second reference temperature becomes a negative pressure. Thus, even if the ink cannot be flowed back from the inkjet head to the ink supply side, the internal pressure of the inkjet head can be prevented from becoming a positive pressure when the ink that has dropped to a predetermined temperature is warmed. As a result, the leakage of ink from the nozzle of the inkjet head when the ink that has dropped to a predetermined temperature is warmed can be prevented.

In order to solve the first problem described above, an inkjet printer of the present invention is an inkjet printer that ejects ink to perform printing, the inkjet printer including an inkjet head that ejects ink; a carriage on which the inkjet head is mounted; a carriage drive mechanism that moves the carriage in a main scanning direction; a pressure adjustment mechanism that accommodates the ink supplied to the inkjet head and adjusts an internal pressure of the inkjet head; an ink warming mechanism that is disposed between the pressure adjustment mechanism and the inkjet head in an ink supply path to the inkjet head and warms the ink supplied to the inkjet head; a temperature sensor for detecting a temperature of the ink; and a controller that controls the inkjet printer; where the ink warming mechanism includes a warming part main body that is block-shaped, an ink passing portion that is formed inside the warming part main body and through which ink passes, and a heater that heats the warming part main body; assuming that a region deviated in the main scanning direction from a printing region where printing is performed is a maintenance region, the controller activates the heater when a temperature detected by the temperature sensor becomes lower than a first reference temperature at a time of printing pause when printing is paused, and when a driving time of the heater after activation exceeds a first reference time set based on the temperature detected by the temperature sensor at a time of activation of the heater before ejecting ink from the inkjet head to perform printing, moves the inkjet head to the maintenance region and forcibly discharges the ink from the inkjet head in the maintenance region.

In order to solve the first problem described above, a method of controlling an inkjet printer of the present invention is a method of controlling an inkjet printer that includes an inkjet head that ejects ink; a carriage on which the inkjet head is mounted; a carriage drive mechanism that moves the carriage in a main scanning direction; a pressure adjustment mechanism that accommodates the ink supplied to the inkjet head and adjusts an internal pressure of the inkjet head; an ink warming mechanism that is disposed between the pressure adjustment mechanism and the inkjet head in an ink supply path to the inkjet head and warms the ink supplied to the inkjet head; a temperature sensor for detecting a temperature of the ink; where the ink warming mechanism includes a warming part main body that is block-shaped, an ink passing portion that is formed inside the warming part main body and through which ink passes, and a heater that heats the warming part main body; assuming that a region deviated in the main scanning direction from a printing region where printing is performed is a maintenance region, the heater is activated when a temperature detected by the temperature sensor becomes lower than a first reference temperature at a time of printing pause when printing is paused, and when a driving time of the heater after activation exceeds a first reference time set based on the temperature detected by the temperature sensor at a time of activation of the heater before ejecting ink from the inkjet head to perform printing, the inkjet head is moved to the maintenance region and ink is forcibly discharged from the inkjet head in the maintenance region.

In the present invention, for example, the first reference time is set so that an internal pressure of the inkjet head when a driving time of the heater after the activation reaches the first reference time becomes a negative pressure. In other words, in the present invention, the first reference time is set so that, for example, an internal pressure of the inkjet head when a driving time of the heater after the activation reaches the first reference time does not become a positive pressure.

In the present invention, the heater is activated in a state where the temperature detected by the temperature sensor is lower than the first reference temperature at the time of printing pause in which printing is paused. When the driving time of the heater after the activation exceeds the first reference time set based on the temperature detected by the temperature sensor at the time of activation of the heater before ejecting ink from the inkjet head to perform printing, the inkjet head is moved to the maintenance region. That is, when ink is warmed by the ink warming mechanism and the temperature of the ink is estimated to exceed the predetermined reference temperature, the inkjet head is moved to the maintenance region. In the present invention, the ink is forcibly discharged from the inkjet head in the maintenance region.

Thus, in the present invention, the first reference time is set so that an internal pressure of the inkjet head when a driving time of the heater after the activation reaches the first reference time becomes a negative pressure. Thus, even if the ink cannot be flowed back from the inkjet head to the ink supply side, the internal pressure of the inkjet head can be prevented from becoming a positive pressure when the ink that has dropped to a predetermined temperature is warmed. As a result, the leakage of ink from the nozzle of the inkjet head when the ink that has dropped to a predetermined temperature is warmed can be prevented.

In the present invention, preferably, the inkjet head is formed with a plurality of nozzles for ejecting ink; the inkjet head includes a plurality of ejection energy generating elements for ejecting ink from each of the plurality of nozzles; and the controller forcibly discharges ink from the inkjet head by driving the ejection energy generating element to eject ink in the maintenance region. With this configuration, for example, the ink can be forcibly discharged from the inkjet head easily and in a short time as compared with a case where the ink is forcibly discharged from the inkjet head by covering the nozzle surface of the inkjet head where nozzles are formed with the cap and sucking the ink from the nozzle.

Furthermore, in order to solve the second problem described above, an inkjet printer of the present invention relates to an inkjet printer that ejects ink to perform printing, the inkjet printer including an inkjet head that ejects ink; a carriage on which the inkjet head is mounted; a carriage drive mechanism that moves the carriage in a main scanning direction; a pressure adjustment mechanism that accommodates the ink supplied to the inkjet head and adjusts an internal pressure of the inkjet head; a temperature sensor that detects a temperature of ink inside the inkjet head, and a controller that controls the inkjet printer; where the inkjet head is formed with a plurality of nozzles that eject ink and a plurality of ink flow paths to which the plurality of nozzles are connected; the inkjet head includes a plurality of ejection energy generating elements for ejecting ink from each of the plurality of nozzles, assuming that a region deviated in the main scanning direction from a printing region where printing is performed is a maintenance region, and a total sum of ejection amounts of ink ejected from each of the plurality of nozzles connected to one of the ink flow paths during a second reference time at a time of printing of ejecting ink from the nozzle to perform printing is a total sum ejection amount, the controller drives the ejection energy generating element to eject ink from the nozzle to perform printing when a temperature detected by the temperature sensor reaches an appropriate ink ejection temperature, and when the temperature detected by the temperature sensor exceeds a third reference temperature higher than the appropriate ink ejection temperature, calculates the total sum ejection amount when going back to before the second reference time from a time point the temperature detected by the temperature sensor exceeds the third reference temperature for the plurality of ink flow paths, and when a first ink flow path which is the ink flow path in which the total sum ejection amount is less than a first reference amount exists, moves the inkjet head to the maintenance region, and at least forcibly discharges the ink from the nozzle connected to the first ink flow path.

Furthermore, in order to solve the second problem described above, a method of controlling an inkjet printer of the present invention relates to a method of controlling an inkjet printer including an inkjet head that ejects ink; a carriage on which the inkjet head is mounted; a carriage drive mechanism that moves the carriage in a main scanning direction; a pressure adjustment mechanism that accommodates the ink supplied to the inkjet head and adjusts an internal pressure of the inkjet head; and a temperature sensor that detects a temperature of ink inside the inkjet head, the inkjet head being formed with a plurality of nozzles that eject ink and a plurality of ink flow paths to which the plurality of nozzles are connected; and the inkjet head including a plurality of ejection energy generating elements for ejecting ink from each of the plurality of nozzles; where assuming that a region deviated in the main scanning direction from a printing region where printing is performed is a maintenance region, and a total sum of ejection amounts of ink ejected from each of the plurality of nozzles connected to one of the ink flow paths during a second reference time at a time of printing of ejecting ink from the nozzle to perform printing is a total sum ejection amount, when a temperature detected by the temperature sensor reaches an appropriate ink ejection temperature, the ejection energy generating element is driven to eject ink from the nozzle to perform printing and when the temperature detected by the temperature sensor exceeds a third reference temperature higher than the appropriate ink ejection temperature, the total sum ejection amount when going back to before the second reference time from a time point the temperature detected by the temperature sensor exceeds the third reference temperature is calculated, and when a first ink flow path which is the ink flow path in which the total sum ejection amount is less than a first reference amount, exists, the inkjet head is moved to the maintenance region, and at least the ink is forcibly discharged from the nozzle connected to the first ink flow path.

In the present invention, at the time of printing of driving the ejection energy generating element and ejecting ink, when the temperature detected by the temperature sensor exceeds the third reference temperature higher than the appropriate ink ejection temperature and the first ink flow path which is an ink flow path in which the total sum ejection amount when going back to before the second reference time from the time point the temperature detected by the temperature sensor exceeds the third reference temperature becomes less than a first reference amount exists, the inkjet head is moved to the maintenance region and at least the ink is forcibly discharged from the nozzle connected to the first ink flow path in the maintenance region.

That is, in the present invention, when the total sum of the ejection amounts of the ink ejected from the plurality of nozzles connected to the specific ink flow path is large during printing, and the number of times of driving of the ejection energy generating element for ejecting ink from the plurality of nozzles is increased, the temperature detected by the temperature sensor becomes high due to the influence of heat generated by the ejection energy generating element. At this time, when the first ink flow path, which is an ink flow path having a small total sum ejection amount, exists, the ink is forcibly discharged from the nozzle connected to the first ink flow path.

Therefore, in the present invention, even if the ink retained in the first ink flow path is warmed by the heat generated by the ejection energy generating element, the internal pressure of the first ink flow path can be prevented from becoming a positive pressure. Therefore, in the present invention, even if an inkjet head in which a plurality of ink flow paths are interiorly formed is used, and the ink cannot be flowed back from the inkjet head to the ink supply side, the leakage of the ink from the nozzle of the inkjet head during printing can be prevented.

In order to solve the second problem described above, an inkjet printer of the present invention is an inkjet printer that ejects ink to perform printing, the inkjet printer including an inkjet head that ejects ink; a carriage on which the inkjet head is mounted; a carriage drive mechanism that moves the carriage in a main scanning direction; a pressure adjustment mechanism that accommodates the ink supplied to the inkjet head and adjusts an internal pressure of the inkjet head; a temperature sensor that detects a temperature of ink inside the inkjet head, and a controller that controls the inkjet printer; where the inkjet head is formed with a plurality of nozzles that eject ink and a plurality of ink flow paths to which the plurality of nozzles are connected; the inkjet head includes a plurality of ejection energy generating elements for ejecting ink from each of the plurality of nozzles, assuming that a region deviated in the main scanning direction from a printing region where printing is performed is a maintenance region, when a number of times of driving of the plurality of ejection energy generating elements driven within a third reference time from a reference time point exceeds a first reference number of times set based on a temperature detected by the temperature sensor at the reference time point at a time of printing of driving the ejection energy generating elements to eject ink, the controller calculates a total sum ejection amount, which is a total sum of ejection amounts of ink ejected from each of the plurality of nozzles connected to the ink flow path, for each of the plurality of ink flow paths until elapse of the third reference time from the reference time point, and when a first ink flow path, which is the ink flow path in which the total sum ejection amount is less than a second reference amount, exists, moves the inkjet head to the maintenance region and at least forcibly discharges the ink from the nozzle connected to the first ink flow path.

In order to solve the second problem described above, a method of controlling an inkjet printer of the present invention relates to a method of controlling is an inkjet printer including an inkjet head that ejects ink; a carriage on which the inkjet head is mounted; a carriage drive mechanism that moves the carriage in a main scanning direction; a pressure adjustment mechanism that accommodates the ink supplied to the inkjet head and adjusts an internal pressure of the inkjet head; and a temperature sensor that detects a temperature of ink inside the inkjet head, the inkjet head being formed with a plurality of nozzles that eject ink and a plurality of ink flow paths to which the plurality of nozzles are connected; and the inkjet head including a plurality of ejection energy generating elements for ejecting ink from each of the plurality of nozzles; where assuming that a region deviated in the main scanning direction from a printing region where printing is performed is a maintenance region, when a number of times of driving of the plurality of ejection energy generating elements driven within a third reference time from a reference time point exceeds a first reference number of times set based on a temperature detected by the temperature sensor at the reference time point at a time of printing of driving the ejection energy generating elements and ejecting ink, a total sum ejection amount, which is a total sum of ejection amounts of ink ejected from each of the plurality of nozzles connected to the ink flow path, is calculated for each of the plurality of ink flow paths until elapse of the third reference time from the reference time point, and when a first ink flow path, which is the ink flow path in which the total sum ejection amount is less than a second reference amount, exists, the inkjet head is moved to the maintenance region and at least the ink is forcibly discharged from the nozzle connected to the first ink flow path.

In the present invention, at the time of printing of driving the ejection energy generating element and ejecting ink, when the number of times of driving of the plurality of ejection energy generating elements driven within the third reference time from the predetermined reference time point exceeds the first reference number of times set based on the temperature detected by the temperature sensor at the reference time point, that is, when it is estimated that the temperature of the ink exceeds the predetermined reference temperature due to the influence of heat generated when the plurality of ejection energy generating elements are driven, the total sum ejection amount is calculated. The total sum ejection amount is the total sum of the ejection amounts of the ink ejected from each of the plurality of nozzles connected to one ink flow path until elapse of the third reference time from the reference time point. When the first ink flow path, which is the ink flow path in which the total sum ejection amount is less than the second reference amount, exists, the inkjet head is moved to the maintenance region and at least the ink is forcibly discharged from the nozzle connected to the first ink flow path in the maintenance region.

During printing, the total sum of the ejection amounts of ink ejected from a plurality of nozzles connected to a specific ink flow path may increase. When the number of times of driving of the ejection energy generating elements for ejecting ink from the plurality of nozzles connected to the specific ink flow path increases, that is, due to the influence of heat generated by the ejection energy generating element, the temperature detected by the temperature sensor increases. At this time, in the present invention, when the first ink flow path, which is an ink flow path having a small total sum ejection amount, exists, the ink is forcibly discharged from the nozzle connected to the first ink flow path.

Therefore, in the present invention, even if the ink retained in the first ink flow path is warmed by the heat generated by the ejection energy generating element, the internal pressure of the first ink flow path can be prevented from becoming a positive pressure. Therefore, in the present invention, even if an inkjet head in which a plurality of ink flow paths are interiorly formed is used, and the ink cannot be flowed back from the inkjet head to the ink supply side, the leakage of the ink from the nozzle of the inkjet head can be prevented.

In the present invention, the controller preferably forcibly discharges ink from the nozzle by driving the ejection energy generating element and ejecting ink in the maintenance region. According to such configuration, the ink can be forcibly discharged from the nozzle easily in a short time.

### Effect of the Invention

As described above, in the present invention, the leakage of ink from the nozzle of the inkjet head when the ink is warmed can be prevented in the inkjet printer.

Furthermore, in the present invention, leakage of ink from the nozzles connected to an ink flow path other than the specific ink flow path when ink is continuously ejected only from the nozzle connected to a specific ink flow path during printing can be prevented in the inkjet printer including an inkjet head in which a plurality of ink flow paths are formed.

### BRIEF DESCRIPTION OF THE DRAWINGS

FIG. 1 is a perspective view of an inkjet printer according to an embodiment of the present invention.

FIG. 2 is a schematic view for describing the configuration of the inkjet printer shown in FIG. 1.

FIG. 3 is a perspective view of a part of a peripheral portion of a carriage shown in FIG. 2.

FIG. 4 is a block diagram for describing the configuration of the inkjet printer shown in FIG. 1.

FIG. 5 is a bottom view for describing the configuration of an inkjet head shown in FIG. 2.

FIG. 6 is a cross-sectional view for describing a configuration of a warming part main body shown in FIG. 3.

FIG. 7 is a cross-sectional view of a pressure adjustment mechanism shown in FIG. 3.

FIG. 8 is an enlarged view of a portion E in FIG. 7.

FIG. 9 is a view illustrating an open state of a communication hole in FIG. 8.

FIG. 10 provides graphs for explaining an operation of preventing leakage of ink from nozzles of the inkjet head shown in FIG. 5.

FIG. 11 is a flowchart illustrating control at the time of printing pause of a printer 1 in the embodiment.

FIG. 12 is a flowchart illustrating control at the time of printing pause of a printer 1 according to a first modified example.

FIG. 13 is a flowchart illustrating control during printing of a printer 1 according to a second modified example.

FIG. 14 is a flowchart illustrating control during printing of a printer 1 according to a third modified example.

FIG. 15 provides enlarged cross-sectional views for describing a configuration of a pressure adjusting damper according to a conventional technique.

### DESCRIPTION OF EMBODIMENT

Hereinafter, an embodiment of the present invention will be described with reference to the drawings.

(Configuration of Inkjet Printer)

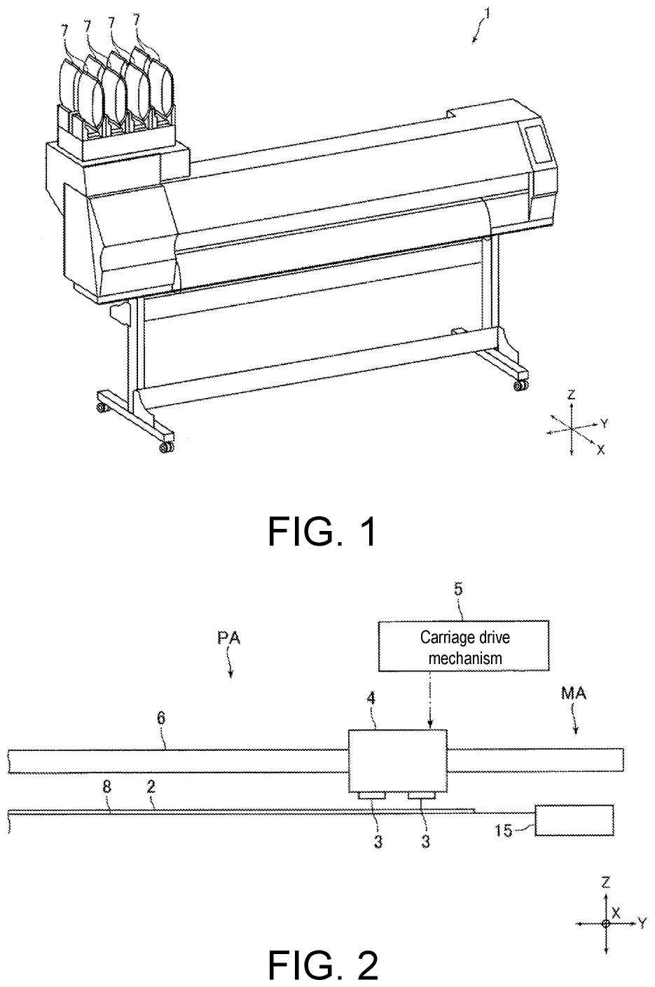

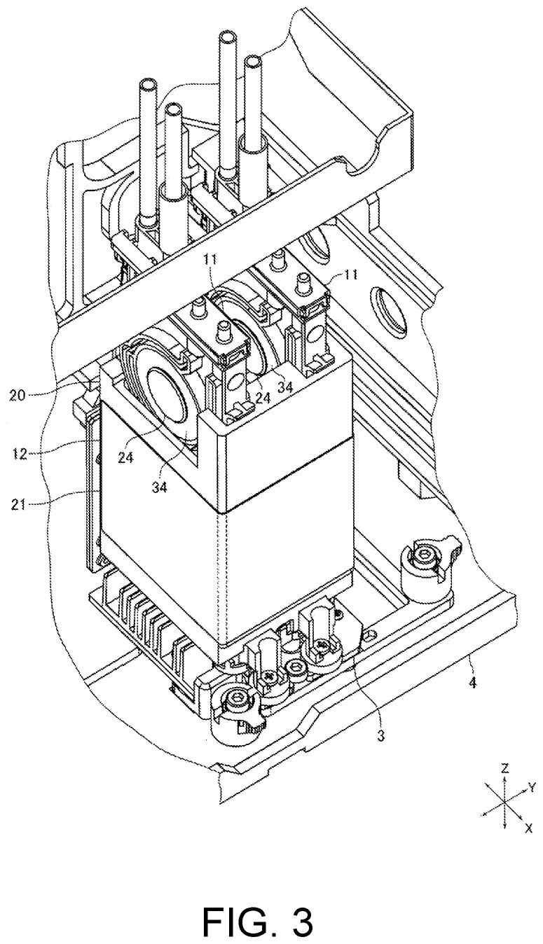

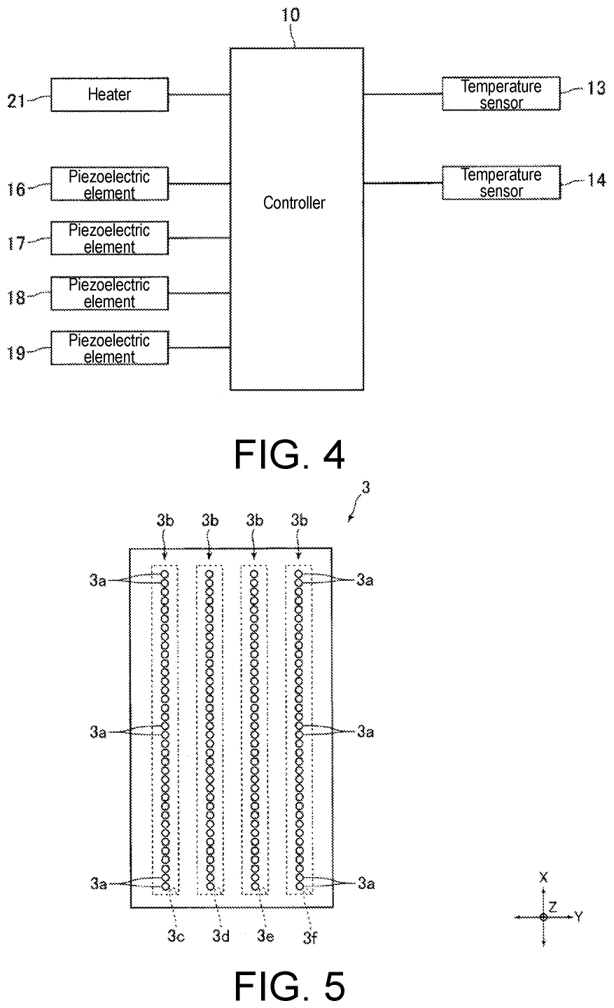

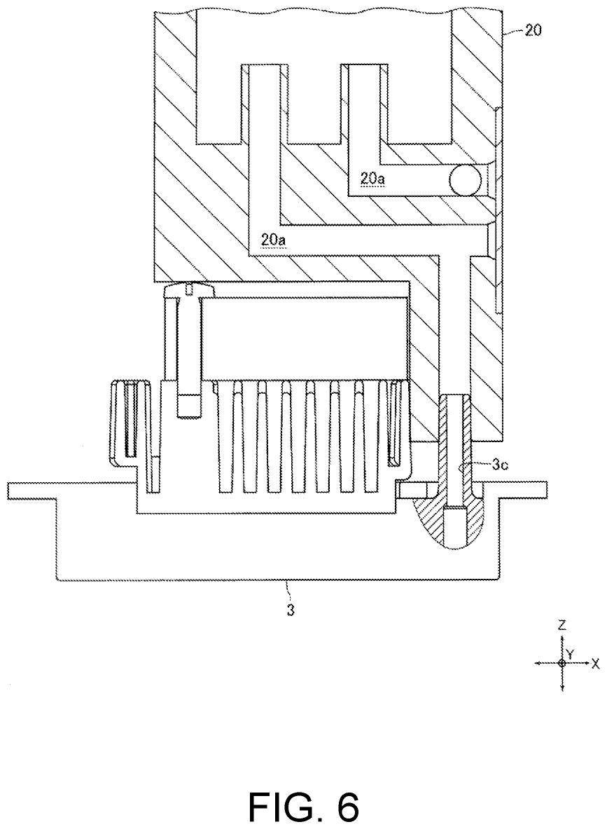

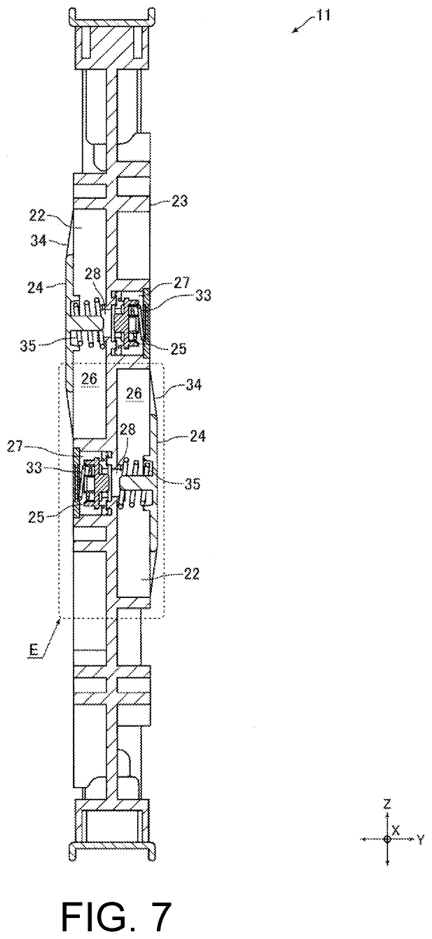

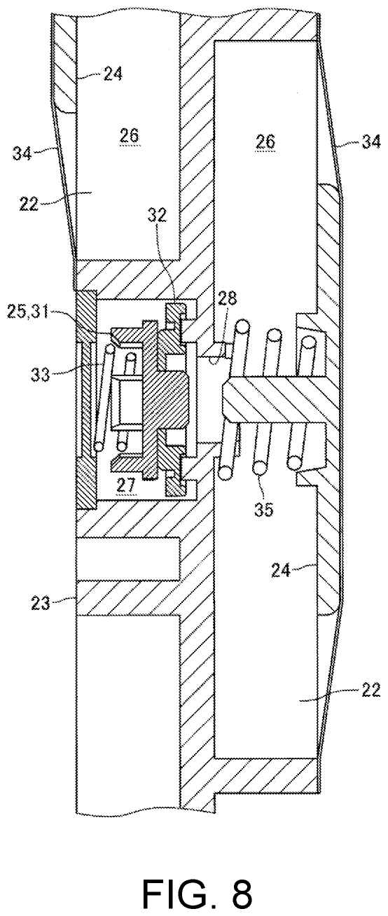

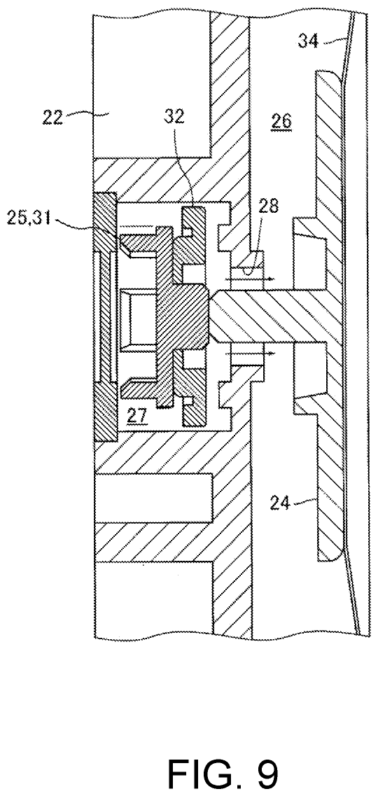

FIG. 1 is a perspective view of an inkjet printer 1 according to an embodiment of the present invention. FIG. 2 is a schematic view for describing the configuration of the inkjet printer 1 shown in FIG. 1. FIG. 3 is a perspective view of a part of a peripheral portion of a carriage 4 shown in FIG. 2. FIG. 4 is a block diagram for describing the configuration of the inkjet printer 1 shown in FIG. 1. FIG. 5 is a bottom view for describing the configuration of an inkjet head 3 shown in FIG. 2. FIG. 6 is a cross-sectional view for describing the configuration of a warming part main body 20 shown in FIG. 3. FIG. 7 is a cross-sectional view of a pressure adjustment mechanism 11 shown in FIG. 3. FIG. 8 is an enlarged view of a portion E in FIG. 7. FIG. 9 is a view illustrating an open state of a communication hole 28 in FIG. 8.

As shown in FIGS. 1 and 2, an inkjet printer 1 (hereinafter referred to as “printer 1”) of the present embodiment is, for example, a business inkjet printer, and ejects ink to perform printing on a print medium 2. The print medium 2 is, for example, printing paper, fabric, resin film, or the like. The printer 1 includes an inkjet head 3 (hereinafter referred to as a “head 3”) that ejects ink toward the print medium 2, a carriage 4 on which the head 3 is mounted, a carriage drive mechanism 5 that moves the carriage 4 in a main scanning direction (Y direction in FIG. 1, etc.), a guide rail 6 that guides the carriage 4 in the main scanning direction, and a plurality of ink tanks 7 in which ink supplied to the head 3 is contained. The printer 1 includes a maintenance part 15 for performing maintenance of the head 3.

As illustrated in FIG. 3, the printer 1 includes a pressure adjustment mechanism 11 for adjusting the internal pressure of the head 3 and an ink warming mechanism 12 for warming the ink supplied to the head 3. As illustrated in FIG. 4, the printer 1 includes temperature sensors 13 and 14 for detecting the temperature of ink. The printer 1 further includes a controller 10 that controls the printer 1. In the following description, a main scanning direction (Y direction) of the printer 1 is assumed as a “left-right direction” and a sub scanning direction (X direction in FIG. 1, etc.) orthogonal to an up-down direction (Z direction in FIG. 1, etc.) and the main scanning direction is assumed as a “front-back direction”.

The head 3 ejects ultraviolet-curable ink (UV ink). The head 3 also ejects ink toward the lower side. As shown in FIG. 5, a plurality of nozzles 3a that eject ink are formed on a lower surface of the head 3. The plurality of nozzles 3a are arrayed in the front-back direction, and a nozzle row 3b is configured by the plurality of nozzles 3a arrayed in the front-back direction. In the present embodiment, a plurality of nozzle rows 3b are formed on the lower surface of the head 3. The plurality of nozzle rows 3b are arrayed in the left-right direction. The head 3 is provided with a plurality of ink flow paths 3c to 3f to which the plurality of nozzles 3a are connected. In the present embodiment, four ink flow paths 3c to 3f are formed inside the head 3. For example, ink of one color among the ink of four colors of magenta (M), yellow (Y), cyan (C), and black (B) flow in each of the four ink flow paths 3c to 3f.

The head 3 includes a plurality of piezoelectric elements 16 to 19 (see FIG. 4) for ejecting ink from each of the plurality of nozzles 3a. The head 3 of the present embodiment includes a plurality of piezoelectric elements 16 for ejecting ink from each of the plurality of nozzles 3a connected to the ink flow path 3c, a plurality of piezoelectric elements 17 for ejecting ink from each of the plurality of nozzles 3a connected to the ink flow path 3d, a plurality of piezoelectric elements 18 for ejecting ink from each of the plurality of nozzles 3a connected to the ink flow path 3e, and a plurality of piezoelectric elements 19 for ejecting ink from each of the plurality of nozzles 3a connected to the ink flow path 3f. The piezoelectric elements 16 to 19 are electrically connected to the controller 10. The piezoelectric elements 16 to 19 according to the present embodiment are ejection energy generating elements.

As shown in FIG. 2, a platen 8 is disposed on the lower side of the head 3. The print medium 2 at the time of printing is placed on the platen 8. The print medium 2 placed on the platen 8 is conveyed in the front-back direction by a medium feeding mechanism (not illustrated). The carriage drive mechanism 5 includes, for example, two pulleys, a belt that is bridged between the two pulleys and that has a part fixed to the carriage 4, and a motor that rotates the pulleys.

Ink is supplied to the pressure adjustment mechanism 11 (see FIG. 3) from the ink tank 7 (see FIG. 1). Specifically, the ink tank 7 is disposed on the upper side than the pressure adjustment mechanism 11, and ink is supplied from the ink tank 7 to the pressure adjustment mechanism 11 by a water head difference. As shown in FIG. 3, the ink warming mechanism 12 is disposed between the pressure adjustment mechanism 11 and the head 3 in the ink supply path to the head 3. Ink is supplied to the ink warming mechanism 12 from the pressure adjustment mechanism 11, and ink is supplied to the head 3 from the ink warming mechanism 12. The pressure adjustment mechanism 11 contains ink supplied to the head 3 via the ink warming mechanism 12. The pressure adjustment mechanism 11 and the ink warming mechanism 12 are mounted on the carriage 4.

The ink warming mechanism 12 is a head-exterior ink warming device disposed exterior to the head 3. The ink warming mechanism 12 has a function of warming the ink supplied to the head 3 to lower the viscosity of the ink supplied to the head 3. The ink warming mechanism 12 is disposed on the upper side of the head 3. In the present embodiment, one ink warming mechanism 12 is provided for one head 3. The ink warming mechanism 12 includes a warming part main body 20 formed in a block shape and a heater 21 attached to the warming part main body 20.

The warming part main body 20 is formed in a substantially rectangular parallelepiped shape as a whole. The warming part main body 20 is made of a metal material having high thermal conductivity. For example, the warming part main body 20 is formed of an aluminum alloy. As shown in FIG. 6, an ink flow path 20a through which ink flows is formed inside the warming part main body 20. Specifically, four ink flow paths 20a are formed inside the warming part main body 20. The four ink flow paths 20a are respectively connected to the four ink flow paths 3c to 3f (see FIG. 5). In the present embodiment, an ink passing portion through which the ink passes is configured by the ink flow path 20a.

As illustrated in FIG. 3, the heater 21 is a sheet heater formed in a sheet shape. Furthermore, the heater 21 is a print heater including a conductive pattern and an insulating sheet (insulating film) that sandwiches the conductive pattern from both sides. In the present embodiment, one heater 21 is attached to the warming part main body 20. The heater 21 is attached to both left and right side surfaces and the front surface of the warming part main body 20. The heater 21 heats the warming part main body 20. As illustrated in FIG. 4, the heater 21 is electrically connected to the controller 10.

As illustrated in FIG. 3, the pressure adjustment mechanism 11 is formed in a flat rectangular parallelepiped shape having a thin thickness in the left-right direction. The pressure adjustment mechanism 11 is attached to the ink warming mechanism 12. In the present embodiment, two pressure adjustment mechanisms 11 are attached to one ink warming mechanism 12. A lower side portion of the pressure adjustment mechanism 11 is accommodated in the warming part main body 20. The two pressure adjustment mechanisms 11 attached to one ink warming mechanism 12 are disposed so as to be adjacent to each other in the left-right direction. The pressure adjustment mechanism 11 is a mechanical pressure damper, and mechanically adjusts the internal pressure of the head 3 without using a pump for pressure adjustment. Furthermore, the pressure adjustment mechanism 11 adjusts the internal pressure of the head 3 (internal pressure of the ink flow paths 3c to 3f in FIG. 5) to a negative pressure.

As shown in FIG. 7, the pressure adjustment mechanism 11 includes a main body frame 23 in which an ink flow path 22 is formed inside. In the present embodiment, two ink flow paths 22 are formed in a main body frame 23. Each of the two ink flow paths 22 formed in the main body frame 23 of one of the two pressure adjustment mechanisms 11 attached to one ink warming mechanism 12 is connected to each of the two ink flow paths 20a of the four ink flow paths 20a (see FIG. 6) formed in the warming part main body 20, and each of the two ink flow paths 22 formed in the main body frame 23 of the other pressure adjustment mechanism 11 is connected to each of the remaining two ink flow paths 20a of the four ink flow paths 20a formed in the warming part main body 20.

The pressure adjustment mechanism 11 includes an opening valve 24 and a sealing valve 25. The ink flow path 22 includes an opening valve accommodation chamber 26 in which an opening valve 24 is accommodated and a sealing valve accommodation chamber 27 in which a sealing valve 25 is accommodated. The opening valve accommodation chamber 26 and the sealing valve accommodation chamber 27 are connected via a communication hole 28. The opening valve accommodation chamber 26 accommodates ink flowing out toward the head 3, and the sealing valve accommodation chamber 27 accommodates ink flowing in from the ink tank 7. The opening valve accommodation chamber 26 and the sealing valve accommodation chamber 27 are arranged so as to be adjacent to each other in the left-right direction.

In one of the two ink flow paths 22, the opening valve accommodation chamber 26 is disposed on the right side, and the sealing valve accommodation chamber 27 is disposed on the left side. In the other ink flow path 22, the opening valve accommodation chamber 26 is disposed on the left side, and the sealing valve accommodation chamber 27 is disposed on the right side. The ink flow path 22 includes a filter chamber disposed between the inlet of the ink flow path 22 and the sealing valve accommodation chamber 27, where a filter is accommodated in the filter chamber.

As illustrated in FIG. 8, the sealing valve 25 includes a valve body 31 and a rubber sealing member 32 fixed to the valve body 31. The sealing valve 25 is biased by the compression coil spring 33 in a direction of closing the communication hole 28. That is, in the sealing valve accommodation chamber 27 disposed on the left side, the sealing valve 25 is biased to the right side by the compression coil spring 33, and in the sealing valve accommodation chamber 27 disposed on the right side, the sealing valve 25 is biased to the left side by the compression coil spring 33. The sealing valve 25 closes the communication hole 28 when ink is not being ejected from the head 3.

The opening valve accommodation chamber 26 is sealed by a thin-film flexible film 34 fixed to the main body frame 23. The flexible film 34 constitutes a wall surface on the outer side of the opening valve accommodation chamber 26 in the left-right direction. That is, in the opening valve accommodation chamber 26 disposed on the right side, the flexible film 34 constitutes a right wall surface of the opening valve accommodation chamber 26, and in the opening valve accommodation chamber 26 disposed on the left side, the flexible film 34 constitutes a left wall surface of the opening valve accommodation chamber 26. The opening valve 24 is biased by the compression coil spring 35 in a direction away from the communication hole 28. That is, in the opening valve accommodation chamber 26 disposed on the right side, the opening valve 24 is biased to the right side by the compression coil spring 35, and in the opening valve accommodation chamber 26 disposed on the left side, the opening valve 24 is biased to the left side by the compression coil spring 35.

The flexible film 34 is disposed on the outer side of the opening valve 24 in the left-right direction. The center portion of the flexible film 34 is pushed toward the outer side in the left-right direction by the opening valve 24 biased by the compression coil spring 35. That is, in the opening valve accommodation chamber 26 disposed on the right side, the center portion of the flexible film 34 is pushed toward the right side, and in the opening valve accommodation chamber 26 disposed on the left side, the center portion of the flexible film 34 is pushed toward the left side. The center portion of the flexible film 34 is pushed in a direction in which the volume of the opening valve accommodation chamber 26 increases.

In the pressure adjustment mechanism 11, when the ink is ejected from the head 3, the internal pressure of the ink flow paths 3c to 3f (see FIG. 5) of the head 3, the internal pressure of the ink flow path 20a (see FIG. 6) of the warming part main body 20, and the internal pressure of the opening valve adjustment chamber 26 decrease. Due to the decrease in the internal pressure, the flexible film 34 is deformed toward the inner side in the left-right direction, and the ink corresponding to the ejection amount is supplied from the opening valve accommodation chamber 26 to the head 3 through the warming part main body 20. When the ink is ejected from the head 3, the flexible film 34 is deformed toward the inner side in the left-right direction against the biasing force of the compression coil spring 35. As a result, as illustrated in FIG. 9, the opening valve 24 moves toward the inner side in the left-right direction. The distal end of the opening valve 24 comes into contact with the sealing valve 25, and the sealing valve 25 moves in a direction of opening the communication hole 28.

When the communication hole 28 is opened, ink is supplied from the sealing valve accommodation chamber 27 to the opening valve accommodation chamber 26 via the communication hole 28 as indicated by an arrow in FIG. 9. When the internal pressure of the opening valve accommodation chamber 26 is increased by the supply of the ink, the flexible film 34 is deformed toward the outer side in the left-right direction by the biasing force of the compression coil spring 35. Accompanying the deformation of the flexible film 34, the opening valve 24 moves in a direction away from the sealing valve 25 When the opening valve 24 is separated from the sealing valve 25, the sealing valve 25 moves toward the communication hole 28 by the biasing force of the compression coil spring 33. When the communication hole 28 is closed by the sealing valve 25, the supply of ink from the sealing valve accommodation chamber 27 to the opening valve accommodation chamber 26 is stopped.

The temperature sensor 13 (see FIG. 4) is, for example, a thermistor. The temperature sensor 13 is a sensor for detecting the temperature of the ink in the warming part main body 20 (see FIG. 3). The temperature sensor 13 is attached to, for example, a side surface of the warming part main body 20, and indirectly detects the temperature of the ink in the ink flow path 20a (see FIG. 6) by detecting the temperature of the warming part main body 20. The temperature sensor 13 also indirectly detects the temperature of the ink inside the head 3 (the temperature of the ink in the ink flow paths 3c to 3f). The temperature sensor 13 is electrically connected to the controller 10 (see FIG. 4). The temperature sensor 13 may be disposed inside the warming part main body 20 to directly detect the temperature of the ink in the ink flow path 20a.

The temperature sensor 14 (see FIG. 4) is, for example, a thermistor. The temperature sensor 14 is a sensor for detecting the temperature of the ink inside the head 3 (see FIG. 3). The temperature sensor 14 is, for example, disposed inside the head 3 to directly detect the temperature of the ink inside the head 3 (the temperature of the ink in the ink flow paths 3c to 3f). Alternatively, the temperature sensor 14 is attached to, for example, a side surface of the head 3, and indirectly detects the temperature of the ink inside the head 3 (the temperature of the ink in the ink flow paths 3c to 3f) by detecting the temperature of the head 3. Furthermore, the temperature sensor 14 also indirectly detects the temperature of the ink in the ink flow path 20a (see FIG. 6). The temperature sensor 14 is electrically connected to the controller 10 (see FIG. 4).

As shown in FIG. 2, a region where printing by the head 3 is performed in the main scanning direction is a printing region PA. The maintenance part 15 is installed in a maintenance region MA, which is a region deviated from the printing region PA in the main scanning direction. In the maintenance part 15, cleaning of the head 3 is carried out so as not to clog the plurality of nozzles 3a of the head 3. Specifically, in the maintenance part 15, flushing for driving the piezoelectric elements 16 to 19 and forcibly ejecting the ink from the nozzle 3a, ink suction of forcibly sucking the ink in the nozzle 3a by covering the nozzle surface where the nozzle 3a is formed with the cap, and the like are performed.

When performing printing on the print medium 2, the controller 10 ejects ink from the head 3 to perform printing when the temperature detected by the temperature sensor 13 reaches the appropriate ink ejection temperature Ta. For example, if the appropriate ink ejection temperature Ta is 60° C., the controller 10 activates the heater 21 to warm the ink when the temperature detected by the temperature sensor 13 is lower than 60° C. at the time of printing of the print medium 2. When the temperature detected by the temperature sensor 13 reaches 60° C. after the heater 21 is activated, the controller 10 drives the piezoelectric elements 16 to 19 and ejects ink from the head 3. Furthermore, the controller 10 controls the printer 1 as described below to prevent ink leakage from the nozzles 3a of the head 3 when the printer 1 in a state where the temperature of the ink in the head 3 is dropped is started and printing is performed.

(Operation of Preventing Leakage of Ink from Nozzle)

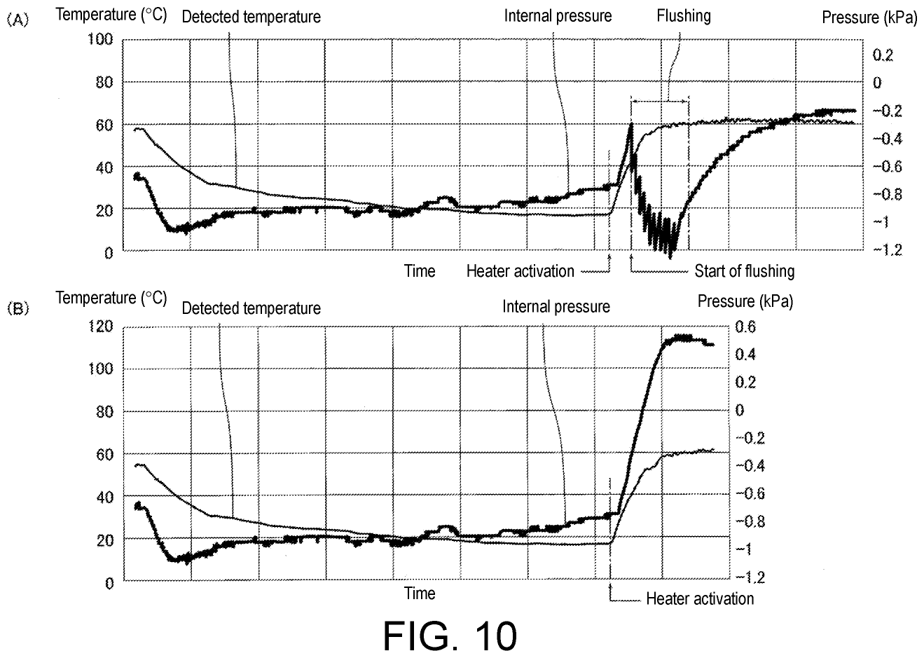

FIG. 10 provides graphs for explaining an operation of preventing leakage of ink from the nozzles 3a of the head 3 shown in FIG. 5. (A) of FIG. 10 is a graph for explaining an ink leakage preventing operation of the present embodiment. (B) of FIG. 10 is a graph for explaining a comparative example in which the ink leakage preventing operation is not performed.

When a printing pause state in which printing is not performed by the printer 1 continues for a certain period of time, the temperature of the ink inside the head 3 drops. The temperature of the ink in the ink flow path 20a of the warming part main body 20 and the ink flow path 22 of the pressure adjustment mechanism 11 also drops. The temperature drop causes the ink to shrink and the volume to decrease. As a result, the internal pressure of each of the head 3, the warming part main body 20, and the opening valve accommodation chamber 26 decreases. Due to the decrease in the internal pressure, the flexible film 34 deforms toward the inner side in the left-right direction. The opening valve 24 moves toward the sealing valve 25 by the deformation of the flexible membrane 34. As the opening valve 24 comes into contact with the sealing valve 25, the sealing valve 25 moves in a direction of opening the communication hole 28. When the communication hole 28 is released, the ink flows from the sealing valve accommodation chamber 27 into the opening valve accommodation chamber 26.

Thereafter, when the heater 21 is activated to warm the ink by the ink warming mechanism 12 in order to perform printing of the print medium 2, the ink expands and the volume increases, and the internal pressure of the head 3, the internal pressure of the warming part main body 20, and the internal pressure of the opening valve accommodation chamber 26 increase (see (B) of FIG. 10). When the internal pressure of the opening valve accommodation chamber 26 increases, the flexible film 34 deforms toward the outer side in the left-right direction. Accompanying the deformation of the flexible film 34, the opening valve 24 moves in a direction away from the sealing valve 25 When the opening valve 24 is separated from the sealing valve 25, the sealing valve 25 moves toward the communication hole 28 and closes the communication hole 28. According to such an action of the sealing valve 25, even if the internal pressure of the opening valve accommodation chamber 26 increases, the communication hole 28 is closed, and hence the ink does not flow back from the opening valve accommodation chamber 26 to the sealing valve accommodation chamber 27.

Here, since the ink flows from the sealing valve accommodation chamber 27 into the opening valve accommodation chamber 26 when the temperature of the ink decreases, when the heater 21 is activated to warm the ink to an appropriate ink ejection temperature, the internal pressure of the head 3, the internal pressure of the warming part main body 20, and the internal pressure of the opening valve accommodation chamber 26 become higher than the internal pressure before the printing pause state. When the internal pressure of the head 3 becomes a positive pressure (see (B) of FIG. 10), the ink that has flowed into the opening valve accommodation chamber 26 leaks from the nozzle 3a of the head 3, and drip occurs. When drip occurs in the printing region PA, the print quality may be affected.

Therefore, in the present embodiment, in order to prevent ink leakage from the nozzle 3a, the controller 10 warms the ink even at the time of the printing pause in which the printing of the print medium 2 is paused, and further moves the head 3 to the maintenance region MA and forcibly discharges the ink from the head 3.

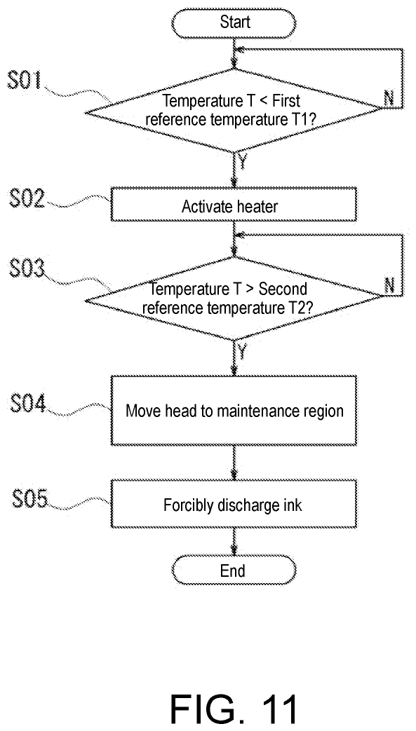

FIG. 11 is a flowchart illustrating control at the time of printing pause of the printer 1 in the embodiment.

The controller 10 periodically detects the temperature T of the ink inside the head 3 by the temperature sensor 13 at the time of printing pause. As shown in FIG. 11, when the temperature T detected by the temperature sensor 13 becomes lower than a first reference temperature T1 (step S01: Yes), the controller 10 activates the heater 21 of the ink warming mechanism 12 to start warming the ink (step S02). The first reference temperature T1 is set to a temperature lower than the appropriate ink ejection temperature Ta.

After the heater 21 is activated, the controller 10 periodically detects the temperature T of the ink by the temperature sensor 13. When the temperature T exceeds a second reference temperature T2 (step S03: Yes), the controller 10 moves the head 3 mounted on the carriage 4 to the maintenance region MA (step S04). The second reference temperature T2 is higher than the first reference temperature T1 and lower than the appropriate ink ejection temperature Ta. The controller 10 forcibly discharges the ink from the head 3 in the maintenance region MA (step S05).

When the printing pause time becomes long, the temperature of the ink inside the head 3 drops. When the heater 21 is activated to start printing again in a state where the temperature of the ink is dropped, the ink may leak from the nozzle 3a as described above, and drip may occur. Therefore, the controller 10 detects the temperature T of the ink by the temperature sensor 13 during the printing pause, and moves the head 3 to the maintenance region MA to forcibly discharged the ink when the temperature T becomes lower than the first reference temperature T1. This reduces the occurrence of drip in the printing region PA at the start of printing.

Here, the controller 10 warms the ink until the temperature exceeds the second reference temperature T2 before moving the head 3 to the maintenance region MA. As the second reference temperature T2, a temperature at which the internal pressure of the head 3 becomes a negative pressure is set. That is, the second reference temperature T2 is set to a temperature at which the internal pressure of the head 3 does not become a positive pressure. Thus, even if the ink is warmed in the printing region PA, drip is less likely to occur from the nozzle 3a. In the maintenance region MA, the controller 10 forcibly discharges ink from the head 3 by performing flushing for driving the piezoelectric elements 16 to 19 and ejecting the ink from the head 3.

For example, the first reference temperature T1 can be set to a temperature of about 25° C. to 20° C., and the second reference temperature T2 can be set to 40° C. The controller 10 activates the heater 21 when the temperature detected by the temperature sensor 13 is lower than 25° C. at the time of printing pause. When the temperature detected by the temperature sensor 13 reaches 40° C. after the activation of the heater 21, the controller 10 moves the head 3 to the maintenance region MA and starts flushing (see (A) of FIG. 10).

In addition, the controller 10 may perform flushing for a predetermined number of times in the maintenance region MA. For example, the controller 10 performs flushing for ten times of driving all of the piezoelectric elements 16 to 19, and ejecting ink from all of the plurality of nozzles 3a. Thereafter, when the temperature T detected by the temperature sensor 13 becomes, for example, 60° C., the controller 10 ejects ink from the head 3 to perform printing of the print medium 2 in the printing region PA. The controller 10 may eject ink from some of the plurality of nozzles 3a when performing flushing.

(Main Effect of Present Embodiment)

As described above, the printer 1 of the present embodiment has the following configuration.

(1) A printer 1 (inkjet printer) includes a head 3 (inkjet head) that ejects ink, a carriage 4 on which the head 3 is mounted, a carriage drive mechanism 5 that moves the carriage 4 in a main scanning direction (Y direction), a pressure adjustment mechanism 11 that accommodates the ink supplied to the head 3 and adjusts an internal pressure of the head 3, an ink warming mechanism 12 that is disposed between the pressure adjustment mechanism 11 and the head 3 in an ink supply path to the head 3 and warms the ink supplied to the head 3, a temperature sensor 13 for detecting a temperature T of the ink, and a controller 10 that controls the printer 1.

The ink warming mechanism 12 includes a block-shaped warming part main body 20, an ink flow path 20a (ink passing portion) that is formed inside the warming part main body 20 and through which ink passes, and a heater 21 that heats the warming part main body 20.

The temperature sensor 13 directly or indirectly detects the temperature of the ink inside the head 3 or the temperature of the ink in the ink flow path 20a.

A region deviated in the main scanning direction (Y direction) from the printing region PA where printing is performed in the printer 1 is defined as a maintenance region MA.

When the temperature T detected by the temperature sensor 13 reaches an appropriate ink ejection temperature Ta, the controller 10 ejects ink from the head 3 to perform printing. The controller 10 activates the heater 21 when the temperature T detected by the temperature sensor 13 becomes lower than the first reference temperature T1 lower than the appropriate ink ejection temperature Ta at the time of printing pause in which printing is paused. After the heater 21 is activated, and the temperature T detected by the temperature sensor 13 exceeds a second reference temperature T2 that is higher than the first reference temperature T1 and lower than the appropriate ink ejection temperature Ta, the controller 10 moves the head 3 to the maintenance region MA. The controller 10 forcibly discharges ink from the head 3 in the maintenance region MA. In the present embodiment, the second reference temperature T2 is set such that the internal pressure of the head 3 when the temperature T detected by the temperature sensor 13 becomes the second reference temperature T2 becomes a negative pressure.

The printer 1 of the present embodiment has a structure in which the ink cannot be flowed back from the head 3 to the ink supply side. Specifically, as illustrated in FIGS. 8 and 9, the printer 1 has a structure in which the ink in the head 3, the ink in the warming part main body 20, and the ink in the opening valve accommodation chamber 26 cannot be flowed back to the sealing valve accommodation chamber 27. In the present embodiment, the printer 1 performs a control of warming and forcibly discharging the ink whose temperature has dropped at the time of printing pause (see (A) of FIG. 10). Thus, as in the comparative example of (B) of FIG. 10, the internal pressure of the head 3 becomes positive pressure by warming the ink at the start of printing, and the occurrence of drip due to the ink leakage from the nozzles 3a of the head 3 can be reduced. As a result, the printer 1 of the embodiment can improve the print quality.

In the present embodiment, the controller 10 performs flushing to forcibly discharge ink from the head 3 in the maintenance region MA. Therefore, in the present embodiment, the ink can be forcibly discharged from the head 3 easily and in a short time as compared with a case where the ink is forcibly discharged from the head 3 by covering the nozzle surface of the head 3 with the cap and forcibly sucking the ink from the nozzle 3a.

Note that a method of controlling the printer 1 by the controller 10 can also obtain a similar effect.

In the present embodiment, the controller 10 uses the temperature detected by the temperature sensor 13 to perform a control of the printer 1 for preventing leakage of ink from the nozzle 3a, but the controller 10 may use the temperature detected by the temperature sensor 14. The appropriate ink ejection temperature Ta, the first reference temperature T1, and the second reference temperature T2 for a case where the temperature detected by the temperature sensor 14 is used may be set to be different from those for a case where the temperature detected by the temperature sensor 13 is used.

(First Modified Example of Method of Controlling Printer)

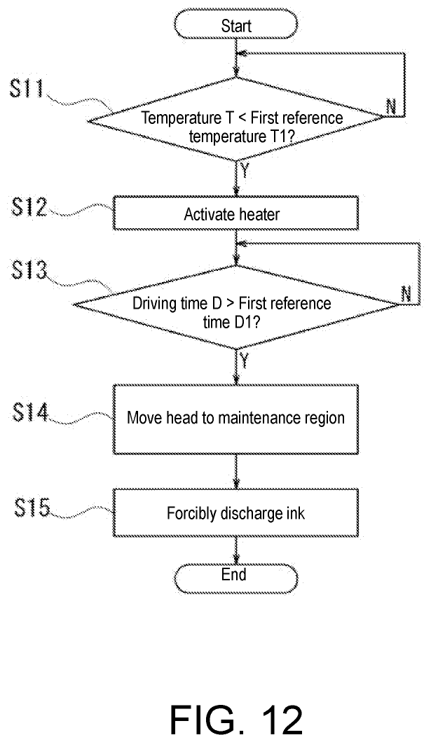

FIG. 12 is a flowchart illustrating control at the time of printing pause of a printer 1 according to a first modified example.

In the first modified example, similarly to the embodiment described above, the ink is discharged from the head 3 at the time of printing pause. In the first modified example, the controller 10 refers to the driving time of the heater 21 to control the movement of the head 3 to the maintenance region MA.

As shown in FIG. 12, when the temperature T detected by the temperature sensor 13 becomes lower than a first reference temperature T1 (step S11: Yes) at the time of printing pause, the controller 10 activates the heater 21 (step S12). The controller 10 refers to the driving time D of the heater 21 after the activation of the heater 21. When the driving time D of the heater 21 exceeds a first reference time D1 (step S13: Yes), the controller 10 moves the head 3 to the maintenance region MA (step S14). The controller 10 forcibly discharges ink from the head 3 in the maintenance region MA (step S15).

The first reference time D1 is a time required for the ink whose temperature has dropped below the first reference temperature T1 to be warmed to the second reference temperature T2 by the heater 21. The first reference time D1 can be set by performing a test, a simulation, or the like in advance. Since the first reference time D1 is based on the second reference temperature T2, the internal pressure of the head 3 is set to be a negative pressure when the driving time D of the heater 21 exceeds the first reference time D1. That is, when the driving time D of the heater 21 after the start exceeds the first reference time D1, the internal pressure of the head 3 does not become positive pressure, so that the ink leakage from the nozzle 3a is reduced.

The controller 10 stores a plurality of reference times associated with a plurality of temperatures. When the temperature sensor 13 detects the temperature T of the ink at the time of activation of the heater 21, the controller 10 may set the reference time associated with the temperature T as the first reference time D1. When the heater temperature, which is the temperature of the heater 21 itself, is variable, each of the plurality of reference times associated with each of the plurality of temperatures may also be associated with the heater temperature and stored in the controller 10.

As described above, in the printer 1 of the first modified example, the controller 10 performs the following control.

(2) The controller 10 activates the heater 21 when the temperature T detected by the temperature sensor 13 becomes lower than the first reference temperature T1 lower than the appropriate ink ejection temperature Ta at the time of printing pause in which printing is paused. When the driving time D of the heater 21 exceeds the first reference time D1 set based on the temperature T detected by the temperature sensor 13 at the time of activation of the heater 21 after activation of the heater 21, the head 3 is moved to the maintenance region MA. The controller 10 forcibly discharges ink from the head 3 in the maintenance region MA.

In the first modified example, similarly to the embodiment described above, the drip from the nozzle 3a at the start of printing can be reduced by forcibly discharging the ink at the time of printing pause. Thus, the print quality of the printer 1 can be improved.

In this modified example, the controller 10 may control the printer 1 using the temperature detected by the temperature sensor 14. When the printer 1 includes an external temperature sensor for measuring the external temperature of the printer 1, the printer 1 may be controlled using the temperature detected by the external temperature sensor. The external temperature sensor can be attached to, for example, the main body frame or the carriage 4 of the printer 1.

(Second Modified Example of Method of Controlling Printer)

In the second modified example, control for reducing the occurrence of ink leakage during printing by the printer 1 will be described.

As shown in FIG. 5, a plurality of ink flow paths 3c to 3f are formed in the head 3, and each of which is connected to the nozzle 3a. As described above, inks of different colors flow in each of the ink flow paths 3c to 3f. In the printer 1, when the color used in the printed matter is biased, only the ink of a specific ink flow path among the ink flow paths 3c to 3f may be continuously ejected, and the ink of other ink flow paths may not be ejected. As an example, only the ink in the ink flow path 3c is continuously ejected, but the ink in the ink flow paths 3d to 3f may not be ejected. In such a case, ink leakage may occur from the nozzles 3a of the ink flow paths 3d to 3f where ink is not ejected. That is, in the printer 1, ink leakage from the nozzle 3a may occur depending on print conditions.

The reason for the ink leakage is considered to be as follows. That is, when the ink is continuously ejected from the nozzle 3a connected to the ink flow path 3c, the number of times of driving of the piezoelectric element 16 (see FIG. 4) that causes ink to be ejected increases. Due to the influence of the heat generated by the piezoelectric element 16, the ink retained in the other ink flow paths 3d to 3f is warmed. When the ink retained in the ink flow paths 3d to 3f is excessively warmed, the ink expands and the volume of the ink increases. Thus, the internal pressure of the ink flow paths 3d to 3f and the internal pressure of the ink flow path 20a (see FIG. 6) and the opening valve accommodation chamber 26 (see FIG. 8) connected to the ink flow paths 3d to 3f are excessively increased.

Therefore, as described in the embodiment, even if the internal pressure of the opening valve accommodation chamber 26 connected to the ink flow paths 3d to 3f increases, the communication hole 28 is opened, and the ink does not flow back from the opening valve accommodation chamber 26 to the sealing valve accommodation chamber 27. Thus, when the internal pressures of the ink flow paths 3d to 3f, the ink flow path 20a, and the opening valve accommodation chamber 26 are excessively increased, the internal pressures of the ink flow paths 3d to 3f become a positive pressure. As a result, ink leakage from the nozzles 3a connected to the ink flow paths 3d to 3f occurs during printing.

When the temperature T detected by the temperature sensor 14 reaches an appropriate ink ejection temperature Ta, the controller 10 drives the piezoelectric elements 16 to 19, which are energy generating elements, and ejects ink from the nozzle 3a to perform printing. The controller 10 performs the following control in order to prevent ink leakage from the nozzle 3a caused by excessive warming of the ink retained in the head 3 by the heat generated by the piezoelectric elements 16 to 19 during printing.

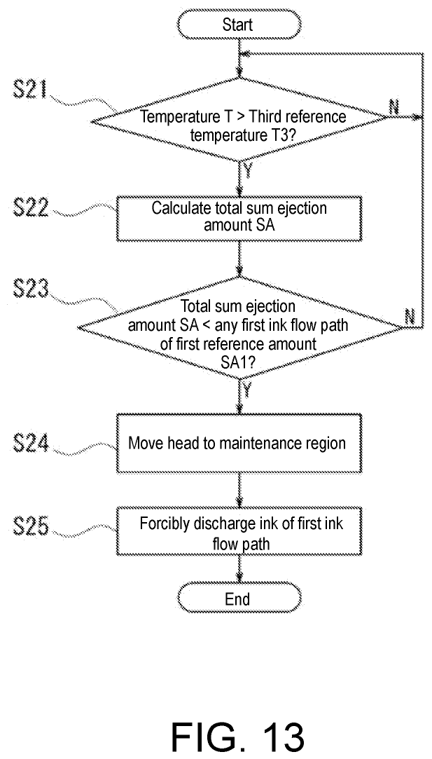

FIG. 13 is a flowchart illustrating control during printing of a printer 1 according to a second modified example.

Here, a predetermined time for performing printing by ejecting ink from the nozzle 3a is set as a second reference time D2. Furthermore, the total sum of the ejection amounts of the ink ejected from each of the plurality of nozzles 3a connected to one ink flow path during the second reference time D2 is set as the total sum ejection amount SA.

As shown in FIG. 13, the controller 10 periodically detects the temperature T of the ink by the temperature sensor 14 during printing, and compares the temperature T with the third reference temperature T3 (step S21). The third reference temperature T3 is a reference value for determining whether the ink is excessively warmed, and is a temperature higher than the appropriate ink ejection temperature Ta.

When the temperature T of the ink exceeds the third reference temperature T3 (step S21: Yes), the controller 10 calculates the total sum ejection amount SA of the ink for each of the ink flow paths 3c to 3f (step S22). Specifically, the controller 10 calculates the total sum ejection amount SA from the time point when the temperature T exceeds the third reference temperature T3 to the time point going back the second reference time D2.

The controller 10 compares the total sum ejection amount SA of each of the ink flow paths 3c to 3f with the first reference amount SA1 (step S23). The first reference amount SA1 is a reference value for determining an ink flow path in which ink is not ejected. When there is an ink flow path (first ink flow path) in which the total sum ejection amount SA is less than the first reference amount SA1 among the ink flow paths 3c to 3f (step S23: Yes), the controller 10 moves the head 3 to the maintenance region MA (step S24). The controller 10 forcibly discharges ink from the nozzle 3a connected to the first ink flow path in the maintenance region MA (step S25).

For example, a case where the ink is continuously ejected from the nozzle 3a connected to the ink flow path 3c but the ink is not ejected from the nozzle 3a connected to the ink flow paths 3d to 3f for a predetermined time at the time of printing of the print medium 2 will be described. In this case, in step S23, the total sum ejection amount SA of each of the ink flow paths 3d to 3f becomes 0 (zero), and is determined to be less than the first reference amount SAL That is, the ink flow paths 3d to 3f correspond to the first ink flow path. In this case, the controller 10 may move the head 3 to the maintenance region MA and forcibly discharge the ink from the nozzles 3a connected to the ink flow paths 3d to 3f in the maintenance region MA. After discharging the ink, the controller 10 may return the head 3 to the printing region PA and restart the printing. Thereafter, the controller 10 can repeat the processes of steps S21 to S25 until printing is completed.

The controller 10 calculates the total sum ejection amount SA based on the print data of the print medium 2 transmitted from the host device of the printer 1 to the controller 10. Furthermore, for example, the controller 10 may forcibly discharge ink from all of the plurality of nozzles 3a connected to each of the ink flow paths 3d to 3f in the maintenance region MA. Moreover, for example, the controller 10 may forcibly discharge ink from the nozzles 3a connected to the ink flow paths 3d to 3f by performing flushing in the maintenance region MA, similar to the embodiment described above. Note that the controller 10 may forcibly discharge ink from some of the plurality of nozzles 3a connected to each of the ink flow paths 3d to 3f in the maintenance region MA.

As described above, in the printer 1 of the second modified example, the controller 10 performs the following control.

(3) When the temperature T detected by the temperature sensor 14 reaches an appropriate ink ejection temperature Ta, the controller 10 drives the piezoelectric elements 16 to 19 (ejection energy generating elements) and ejects ink from the nozzle 3a to perform printing. When the temperature T detected by the temperature sensor 14 exceeds the third reference temperature T3 higher than the appropriate ink ejection temperature Ta at the time of printing of the print medium 2, the controller 10 calculates the total sum ejection amount SA of the plurality of ink flow paths 3c to 3f when going back to before the second reference time D2 from the time point the temperature T detected by the temperature sensor 14 exceeds the third reference temperature T3, and when the first ink flow path, which is the ink flow paths 3c to 3f in which the total sum ejection amount SA is less than the first reference amount SA1, exists, moves the head 3 to the maintenance region MA and forcibly discharges ink from the nozzle 3a connected to the first ink flow path in the maintenance region MA.

For example, when the total sum of the ejection amounts of ink ejected from the plurality of nozzles 3a connected to the ink flow path 3c is large during printing, the number of times of driving of the piezoelectric element 16 for ejecting ink from the nozzle 3a connected to the ink flow path 3c increases. As a result, when the temperature T detected by the temperature sensor 14 becomes high due to the influence of the heat generated by the piezoelectric element 16, the ink is forcibly discharged from the nozzles 3a connected to the ink flow paths 3d to 3f with a small total sum ejection amount SA.

Therefore, in this modified example, even if the ink retained in the ink flow paths 3d to 3f is warmed by the heat generated by the piezoelectric element 16, the internal pressure of the ink flow paths 3d to 3f can be prevented from becoming a positive pressure. As described above, the printer 1 cannot flow back the ink from the head 3 to the ink supply side, but the ink leakage from the nozzle 3a of the head 3 can be prevented even during the printing by the control of the second modified example, and hence the print quality can be improved.

In this modified example, for example, even when the ink is ejected continuously from the nozzle 3a connected to the ink flow path 3c, that is, even when the ink flow path 3c does not correspond to the first ink flow path, the ink may be forcibly discharged also from the nozzle 3a connected to the ink flow path 3c in the maintenance region MA.

Furthermore, if the temperature of the ink in the head 3 can be appropriately detected by the temperature sensor 13, the controller 10 may use the temperature detected by the temperature sensor 13 in this modified example. Alternatively, both the temperature detected by the temperature sensor 13 and the temperature detected by the temperature sensor 14 may be used.

(Third Modified Example of Method of Controlling Printer)

In the third modified example, control for reducing the occurrence of ink leakage during printing by the printer 1 will be described, similar to the second modified example. In the second modified example, the controller 10 refers to the temperature T detected by the temperature sensor 14, but in the third modified example, the controller 10 refers to the number of times of driving K of the piezoelectric element 16 to 19.

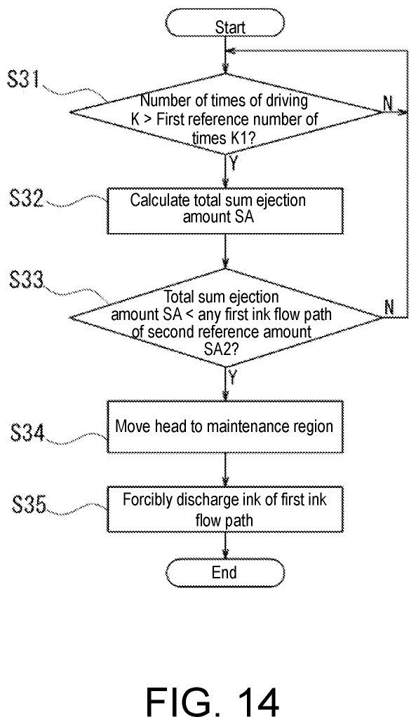

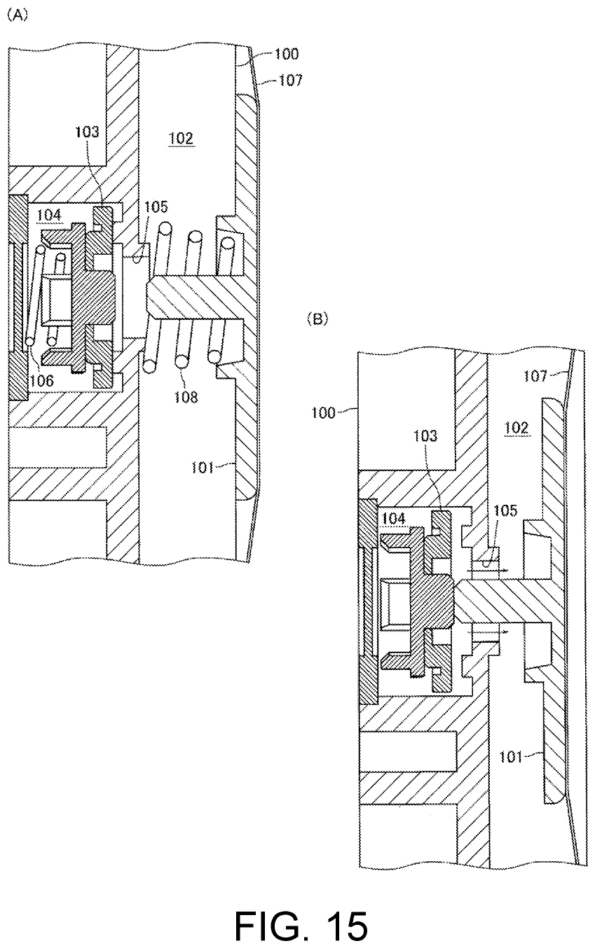

FIG. 14 is a flowchart illustrating control during printing of a printer 1 according to the third modified example.

As illustrated in FIG. 14, the controller 10 refers to the number of times of driving K of each of the plurality of piezoelectric elements 16 to 19 during printing (step S31). The number of times of driving K is the number of times the piezoelectric elements 16 to 19 are driven within the third reference time D3 from the reference time point after the start of printing.

When the number of times of driving K of any one of the piezoelectric elements 16 to 19 exceeds the first reference number of times K1 (step S31: Yes), the controller 10 calculates the total sum ejection amount SA of ink for each of the ink flow paths 3c to 3f (step S32).

The first reference number of times K1 is set based on the temperature detected by the temperature sensor 14 at the reference time point.

Furthermore, the total sum ejection amount SA is the total sum of the ejection amounts of the ink ejected from each of the plurality of nozzles 3a connected to each ink flow path 3c to 3f until elapse of the third reference time D3 from the reference time point.

The controller 10 compares the total sum ejection amount SA of each of the ink flow paths 3c to 3f with the second reference amount SA2 (step S33). When there is an ink flow path (first ink flow path) in which the total sum ejection amount SA is less than the second reference amount SA2 among the ink flow paths 3c to 3f (step S33: Yes), the controller 10 moves the head 3 to the maintenance region MA (step S34). The controller 10 forcibly discharges ink from the nozzle 3a connected to the first ink flow path in the maintenance region MA (step S35).

For example, a case where the ink is continuously ejected from the nozzle 3a connected to the ink flow path 3c but the ink is not ejected from the nozzle 3a connected to the ink flow paths 3d to 3f for a predetermined time at the time of printing of the print medium 2 will be described. In this case, in step S33, the total sum ejection amount SA of each of the ink flow paths 3d to 3f becomes 0 (zero), and is determined to be less than the second reference amount SA2. In this case, the controller 10 may forcibly discharge the ink from the nozzles 3a connected to the ink flow paths 3d to 3f by performing flushing in the maintenance region MA. After discharging the ink, the controller 10 may return the head 3 to the printing region PA and restart the printing. Thereafter, the controller 10 can repeat the processes of steps S31 to S35 until printing is completed.

In this case, the controller 10 calculates the number of times of driving K of the piezoelectric element 16 based on the print data of the print medium 2 transmitted from the host device of the printer 1 to the controller 10. The controller 10 also calculates the total sum ejection amount SA based on the print data of the print medium 2 transmitted from the host device of the printer 1 to the controller 10. Furthermore, in this case, for example, the controller 10 may forcibly discharge ink from all of the plurality of nozzles 3a connected to each of the ink flow paths 3d to 3f in the maintenance region MA. Alternatively, the controller 10 may forcibly discharge ink from some of the plurality of nozzles 3a connected to each of the ink flow paths 3d to 3f in the maintenance region MA.

The first reference number of times K1 corresponds to the number of times of driving the piezoelectric element 16 until elapse of the third reference time from the reference time point when the temperature T detected by the temperature sensor 14 reaches a predetermined reference temperature due to the influence of heat generated when the piezoelectric element 16 is driven. The reference temperature in this case is the third reference temperature T3 in the second modified example described above. The controller 10 stores a plurality of reference number of times associated with each of a plurality of temperatures. The controller 10 detects the temperature T with the temperature sensor 14 at the reference time point, and sets the reference number of times associated with the temperature T as the first reference number of times K1.

As described above, in the printer 1 of the third modified example, the controller 10 performs the following control.

(4) The controller 10 drives the piezoelectric elements 16 to 19 (ejection energy generating element) and ejects ink to perform printing. At the time of printing, when the number of times of driving K of the plurality of piezoelectric elements 16 to 19 driven within the third reference time T3 from the reference time point exceeds the first reference number of times K1 set based on the temperature T detected by the temperature sensor 14 at the reference time point, and when there is a first ink flow path, which is an ink flow path in which the total sum ejection amount SA, which is the total sum of the ejection amounts of the inks ejected from each of the plurality of nozzles 3a connected to one ink flow paths 3c to 3f, becomes less than the second reference amount SA2 until elapse of the third reference time D3 from the reference time point, the controller 10 moves the head 3 to the maintenance region MA and at least forcibly discharges the ink from the nozzles 3a connected to the first ink flow path.

In this modified example, for example, when the total sum of the ejection amounts of ink ejected from the plurality of nozzles 3a connected to the ink flow path 3c is large during printing, the number of times of driving of the piezoelectric element 16 for ejecting ink from the nozzle 3a connected to the ink flow path 3c increases. In this case, the temperature detected by the temperature sensor 14 becomes higher due to the influence of heat generated by the piezoelectric element 16. In this case, the ink is forcibly discharged from the nozzle 3a connected to the ink flow paths 3d to 3f with a small total sum ejection amount SA.

Thus, in this modified example as well, even if the ink retained in the ink flow paths 3d to 3f is warmed by the heat generated by the piezoelectric element 16, the internal pressure of the ink flow paths 3d to 3f can be prevented from becoming a positive pressure, similar to the second modified example described above. As described above, the printer 1 cannot flow back the ink from the head 3 to the ink supply side, but the ink leakage from the nozzle 3a of the head 3 can be prevented even during the printing by the control of the third modified example, and hence the print quality can be improved.

In this modified example, for example, even when the ink is ejected continuously from the nozzle 3a connected to the ink flow path 3c, that is, even when the ink flow path 3c does not correspond to the first ink flow path, the ink may be forcibly discharged also from the nozzle 3a connected to the ink flow path 3c in the maintenance region MA. Furthermore, in this modified example, if the temperature of the ink in the head 3 can be appropriately detected by the temperature sensor 13, the first reference number of times K1 may be set based on the temperature detected by the temperature sensor 13 at the reference time point.

(Other Embodiments)

The embodiment and modified examples described above are an example of a preferred embodiment of the present invention, but this is not the sole case, and various modified examples can be made within a scope not changing the gist of the present invention.

In the embodiment and the first to third modified examples described above, when forcibly discharging ink from the nozzles 3a in the maintenance region MA, the controller 10 may forcibly discharge the ink from the nozzles 3a by covering the nozzle surface of the head 3 with a cap and forcibly sucking the ink from the nozzles 3a. In the embodiment and the first to third modified examples described above, the heater 21 may be a heater other than the sheet heater.

In the embodiment and the first to third modified examples described above, the number of ink flow paths formed inside the head 3 may be two or three, or may be five or more. In the embodiment and the first modified example described above, the number of ink flow paths formed inside the head 3 may be one. Furthermore, in the embodiment and the first to third modified examples described above, the number of ink flow paths 22 formed inside the pressure adjustment mechanism 11 may be one. Moreover, in the second and third modified examples described above, the printer 1 may not include the ink warming mechanism 12.

In the embodiment and the first to third modified examples described above, instead of the ink flow path 20a, an ink reservoir (ink chamber) in which ink is accumulated may be formed inside the warming part main body 20. In this case, an ink passing portion through which the ink passes is configured by the ink reservoir. In the embodiment and the first to third modified examples described above, in addition to the ink flow path 20a, an ink reservoir may be formed inside the warming part main body 20. In this case, an ink passing portion through which the ink passes is configured by the ink flow path 20a and the ink reservoir.

In the embodiment and the first to third modified examples described above, the ejection energy generating element for ejecting ink from the nozzle 3a is the piezoelectric elements 16 to 19, but the ejection energy generating element for ejecting ink from the nozzle 3a may be a heater (heat generating element). That is, in the embodiment and the first to third modified examples described above, the printer 1 ejects the ink from the nozzle 3a by the piezo method, but the printer 1 may eject the ink from the nozzle 3a by the thermal method.

Note that in the embodiment and the first to third modified examples described above, the printer 1 may include a table on which the print medium 2 is placed in place of the platen 8, and a table drive mechanism for moving the table in the front-back direction. In addition, in the embodiment and the first to third modified examples described above, the printer 1 may be a 3D printer that shapes a three-dimensional object. Furthermore, in the embodiment and the first to third modified examples described above, the ink ejected by the head 3 may be aqueous ink or may be solvent ink.

### REFERENCE SIGNS LIST

1 Printer (inkjet printer)
3 Head (inkjet head)
3a Nozzle
3c to 3f Ink flow path
4 Carriage
5 Carriage drive mechanism
10 Controller
11 Pressure adjustment mechanism
12 Ink warming mechanism
13, 14 Temperature sensor
16 to 19 Piezoelectric element (ejection energy generating element)
20 Warming part main body
20a Ink flow path (ink passing portion)
21 Heater
MA Maintenance region
PA Printing region
Y Main scanning direction

1. An inkjet printer that ejects ink to perform printing, the inkjet printer comprising:
an inkjet head that ejects ink; a carriage on which the inkjet head is mounted; a carriage drive mechanism that moves the carriage in a main scanning direction; a pressure adjustment mechanism that accommodates the ink supplied to the inkjet head and adjusts an internal pressure of the inkjet head; an ink warming mechanism that is disposed between the pressure adjustment mechanism and the inkjet head in an ink supply path to the inkjet head and warms the ink supplied to the inkjet head; a temperature sensor for detecting a temperature of the ink; and a controller that controls the inkjet printer; wherein
the ink warming mechanism includes a warming part main body that is block-shaped, an ink passing portion that is formed inside the warming part main body and through which ink passes, and a heater that heats the warming part main body;
the temperature sensor directly or indirectly detects a temperature of ink inside the inkjet head or a temperature of ink in the ink passing portion;
assuming that a region deviated in the main scanning direction from a printing region where printing is performed is a maintenance region,
the controller ejects ink from the inkjet head to perform printing when a temperature detected by the temperature sensor becomes an appropriate ink ejection temperature, and
the controller activates the heater when a temperature detected by the temperature sensor becomes lower than a first reference temperature lower than the appropriate ink ejection temperature at a time of printing pause when printing is paused, and when the temperature detected by the temperature sensor exceeds a second reference temperature higher than the first reference temperature and lower than the appropriate ink ejection temperature after activation of the heater, moves the inkjet head to the maintenance region and forcibly discharges the ink from the inkjet head in the maintenance region.

2. The inkjet printer as set forth in claim 1, wherein the second reference temperature is set so that an internal pressure of the inkjet head when a temperature detected by the temperature sensor reaches the second reference temperature becomes a negative pressure.

3. An inkjet printer that ejects ink to perform printing, the inkjet printer comprising:
an inkjet head that ejects ink; a carriage on which the inkjet head is mounted; a carriage drive mechanism that moves the carriage in a main scanning direction; a pressure adjustment mechanism that accommodates the ink supplied to the inkjet head and adjusts an internal pressure of the inkjet head; an ink warming mechanism that is disposed between the pressure adjustment mechanism and the inkjet head in an ink supply path to the inkjet head and warms the ink supplied to the inkjet head; a temperature sensor for detecting a temperature of the ink; and a controller that controls the inkjet printer; wherein
the ink warming mechanism includes a warming part main body that is block-shaped, an ink passing portion that is formed inside the warming part main body and through which ink passes, and a heater that heats the warming part main body;
assuming that a region deviated in the main scanning direction from a printing region where printing is performed is a maintenance region,
the controller activates the heater when a temperature detected by the temperature sensor becomes lower than a first reference temperature at a time of printing pause when printing is paused, and when a driving time of the heater after activation exceeds a first reference time set based on the temperature detected by the temperature sensor at a time of activation of the heater before ejecting ink from the inkjet head to perform printing, moves the inkjet head to the maintenance region and forcibly discharges the ink from the inkjet head in the maintenance region.

4. The inkjet printer as set forth in claim 3, wherein the first reference time is set so that an internal pressure of the inkjet head when a driving time of the heater after the activation reaches the first reference time becomes a negative pressure.

5. The inkjet printer as set forth in claim 1, wherein
the inkjet head is formed with a plurality of nozzles for ejecting ink;
the inkjet head includes a plurality of ejection energy generating elements for ejecting ink from each of the plurality of nozzles; and
the controller forcibly discharges ink from the inkjet head by driving the ejection energy generating element and ejecting ink in the maintenance region.

6. An inkjet printer that ejects ink to perform printing, the inkjet printer comprising:
an inkjet head that ejects ink; a carriage on which the inkjet head is mounted; a carriage drive mechanism that moves the carriage in a main scanning direction; a pressure adjustment mechanism that accommodates the ink supplied to the inkjet head and adjusts an internal pressure of the inkjet head; a temperature sensor that detects a temperature of ink inside the inkjet head, and a controller that controls the inkjet printer; wherein
the inkjet head is formed with a plurality of nozzles that eject ink and a plurality of ink flow paths to which the plurality of nozzles are connected;
the inkjet head includes a plurality of ejection energy generating elements for ejecting ink from each of the plurality of nozzles,
assuming that a region deviated in the main scanning direction from a printing region where printing is performed is a maintenance region, and a total sum of ejection amounts of ink ejected from each of the plurality of nozzles connected to one of the ink flow paths during a second reference time at a time of printing of ejecting ink from the nozzle to perform printing is a total sum ejection amount,
the controller drives the ejection energy generating element and ejects ink from the nozzle to perform printing when a temperature detected by the temperature sensor reaches an appropriate ink ejection temperature, and when the temperature detected by the temperature sensor exceeds a third reference temperature higher than the appropriate ink ejection temperature, calculates the total sum ejection amount when going back to before the second reference time from a time point the temperature detected by the temperature sensor exceeds the third reference temperature for the plurality of ink flow paths, and when a first ink flow path which is the ink flow path in which the total sum ejection amount is less than a first reference amount exists, moves the inkjet head to the maintenance region, and at least forcibly discharges ink from the nozzle connected to the first ink flow path.

7. An inkjet printer that ejects ink to perform printing, the inkjet printer comprising:
an inkjet head that ejects ink; a carriage on which the inkjet head is mounted; a carriage drive mechanism that moves the carriage in a main scanning direction; a pressure adjustment mechanism that accommodates the ink supplied to the inkjet head and adjusts an internal pressure of the inkjet head; a temperature sensor that detects a temperature of ink inside the inkjet head, and a controller that controls the inkjet printer; wherein
the inkjet head is formed with a plurality of nozzles that eject ink and a plurality of ink flow paths to which the plurality of nozzles are connected;
the inkjet head includes a plurality of ejection energy generating elements for ejecting ink from each of the plurality of nozzles,
assuming that a region deviated in the main scanning direction from a printing region where printing is performed is a maintenance region,
when a number of times of driving of the plurality of ejection energy generating elements driven within a third reference time from a reference time point exceeds a first reference number of times set based on a temperature detected by the temperature sensor at the reference time point at a time of printing of driving the ejection energy generating elements to eject ink, the controller calculates a total sum ejection amount, which is a total sum of ejection amounts of ink ejected from each of the plurality of nozzles connected to the ink flow path, for each of the plurality of ink flow paths until elapse of the third reference time from the reference time point, and when a first ink flow path, which is the ink flow path in which the total sum ejection amount is less than a second reference amount, exists, moves the inkjet head to the maintenance region and at least forcibly discharges the ink from the nozzle connected to the first ink flow path.

8. The inkjet printer as set forth in claim 6, wherein the controller forcibly discharges ink from the nozzle by driving the ejection energy generating element and ejecting ink in the maintenance region.

9. (canceled)

10. (canceled)

11. (canceled)

12. (canceled)

13. (canceled)

14. (canceled)

15. The inkjet printer as set forth in claim 2, wherein
the inkjet head is formed with a plurality of nozzles for ejecting ink;
the inkjet head includes a plurality of ejection energy generating elements for ejecting ink from each of the plurality of nozzles; and
the controller forcibly discharges ink from the inkjet head by driving the ejection energy generating element and ejecting ink in the maintenance region.

16. The inkjet printer as set forth in claim 3, wherein
the inkjet head is formed with a plurality of nozzles for ejecting ink;
the inkjet head includes a plurality of ejection energy generating elements for ejecting ink from each of the plurality of nozzles; and
the controller forcibly discharges ink from the inkjet head by driving the ejection energy generating element and ejecting ink in the maintenance region.

17. The inkjet printer as set forth in claim 4, wherein
the inkjet head is formed with a plurality of nozzles for ejecting ink;
the inkjet head includes a plurality of ejection energy generating elements for ejecting ink from each of the plurality of nozzles; and
the controller forcibly discharges ink from the inkjet head by driving the ejection energy generating element and ejecting ink in the maintenance region.

18. The inkjet printer as set forth in claim 7, wherein the controller forcibly discharges ink from the nozzle by driving the ejection energy generating element and ejecting ink in the maintenance region.
